(19) United States
(12) Patent Application Publication
(10) Pub. No.: US 2024/0110003 A1
(43) Pub. Date: Apr. 4, 2024

(54) FLAME RETARDANT COMPOSITIONS CONTAINING POLYCYCLIC-OLEFINIC POLYMER WITH OLEFINIC FUNCTIONALITY FOR FORMING LOW-LOSS FILMS HAVING IMPROVED DIELECTRIC AND THERMAL PROPERTIES

(71) Applicant: PROMERUS, LLC, AKRON, OH (US)

(72) Inventors: RUSLAN BURTOVYY, AKRON, OH (US); PRAMOD KANDANARACHCHI, AKRON, OH (US); CHERYL BURNS, AKRON, OH (US); CAROLYN SCHERGER, AKRON, OH (US)

(73) Assignee: PROMERUS, LLC, AKRON, OH (US)

(21) Appl. No.: 18/243,390

(22) Filed: Sep. 7, 2023

Related U.S. Application Data
(60) Provisional application No. 63/404,374, filed on Sep. 7, 2022.

(51) Int. Cl. C08G 61/08; C08F 236/20; C08K 3/38; C08K 5/3492; C08K 5/5313; C08L 65/00; H01Q 1/38

(52) U.S. Cl. CPC C08G 61/08; C08F 236/20; C08K 3/38; C08K 5/3492; C08K 5/5313; C08L 65/00; H01Q 1/38; C08G 2261/3324; C08K 2003/385; C08K 2201/005; C08L 2201/02; C08L 2201/08; C08L 2203/16; C08L 2203/206

(57) ABSTRACT

Embodiments in accordance with the present invention encompass compositions containing the polymer formed from a variety of polycycloolefinic monomers optionally at least one of which monomer contains an additional unpolymerized ethylenic bond, organophosphorus compound, optionally hexagonal boron nitride, a crosslinker, a free radical initiator, a tackifier and one or more suitable additives. The compositions of this invention can be formed into a variety of three-dimensional insulating articles upon exposure to suitable high temperature, such as for example films. The objects formed from the compositions of this invention exhibit hitherto unattainable low dielectric constant and low-loss properties, fire retardancy and very high thermal properties. The compositions of this invention may additionally contain one or more organic or inorganic filler materials, which provide improved thermo-mechanical properties in addition to excellent thermal and dielectric properties. The compositions of this invention are useful in various applications, including as insulating materials in millimeter wave radar antennas, among others. The films formed from the compositions of this invention has a UL-94 rating of V-0, dielectric constant (Dk) less than 2.7 and dielectric dissipation factor (Df) of less than 0.0009.

### CROSS REFERENCE TO RELATED APPLICATIONS

This application claims the benefit of U.S. Provisional Application No. 63/404,374, filed Sep. 7, 2022, which is incorporated herein by reference in its entirety.

### BACKGROUND OF THE INVENTION

### Field of the Invention

Embodiments in accordance with the present invention relate generally to compositions containing polymers containing olefinic functionality in combination with fire retardant organophosphorus compound, hexagonal boron nitride, a tackifier, a crosslinker, a free radical initiator and one or more additives. More specifically, the polymers employed herein are formed from two or more polycycloolefinic monomers, such as for example norbornene type monomers, at least one of which monomers contain a free olefinic functionality. The compositions of this invention can readily be formed into films, which are useful as low loss thermosets and prepregs for copper clad laminates which not only exhibit low dielectric constant and low-loss properties but also very high thermal properties and exhibit excellent fire retarding properties. For example, films formed from the compositions of this invention generally exhibit high glass transition temperature, which range from about 250° C. to 280° C., and also exhibit low dielectric constant (from about 2.4 to 2.8 at a frequency of 10 GHz), low dielectric dissipation factor (from about 0.0008 to 0.002 at a frequency of 10 GHz). Accordingly, the polymers and composition of this invention find applications as insulating materials in a variety of applications including electromechanical devices having applications in the fabrication of a number of automotive parts, among others.

### Description of the Art

It is well known in the art that insulating materials having low dielectric constant (Dk) and low-loss, also referred to as dielectric dissipation factor, (Df) are important in printed circuit boards catering to electrical appliances and automotive parts and other applications. Generally, in most of such devices the insulating materials that are suitable must have dielectric constant lower than 3 and low-loss lower than 0.002 at high frequencies such as for example greater than 10 GHz. Also, there is an increased interest in developing organic dielectric materials as they are easy to fabricate among other advantages.

However, the use of such materials in printed circuit boards as copper-clad laminates need high performance thermosets having high glass transition temperatures (T g), low CTEs, low Dk/Df, high peel strength on copper and good reliability at high temperature storage. The ability to form prepreg (composite with glass cloth), B-staging capability (generate a layer of material that is not cross linked or partially cross linked) and film fusing capability for fabricating layered structures are also important. Most commercial materials available in the art have not attained all of these properties, especially low Dk/Df and high glass transition temperatures, higher than 250° C.

In addition, there are significant technical challenges in developing such insulating materials meeting all of the requirements. One such challenge is that such materials exhibit very high glass transition temperature (T g), which is preferably greater than 250° C. or even higher than 250° C. due to the process conditions used in the manufacture of printed circuit boards as well as harsh conditions the devices may encounter, such as for example millimeter-wave Radar antennas used in the automobiles and other terminal equipment in 5G devices.

Although films made from the addition polymerization of norbornene derivatives containing long side chains, such as for example, 5-hexylnorbornene (HexNB) and 5-decylnorbornene (DecNB) are known to have low Dk and Df due to their hydrophobic nature these films exhibit high CTE (>200 ppm/K) and low T g. See, for example, JP 2016037577A and JP 2012121956A.

It has also been reported in the literature that certain of the polymers, such as for example, fluorinated poly-ethylene, poly-ethylene and poly-styrene feature low Dk/Df but all of such polymers are unsuitable as organic insulating materials as they exhibit very low glass transition temperatures, which can be much lower than 150° C. Further, it has also been reported in the literature that generally low CTE and high T g polymers can be generated when certain substituted norbornenes substituted with polar groups such an ester or alcohol groups are incorporated. However, incorporation of such groups will increase both Dk and Df due to their polarizability under an electromagnetic field, particularly at high frequencies. Therefore, such polar group substituted norbornenes are unsuitable in forming insulating materials as contemplated herein. In addition, there is a heightened need to ensure that the materials employed in such applications are fire retardant due to high heat generated in many of the applications.

U.S. Pat. No. 10,104,769 B2 discloses a circuit subassembly embodiment containing a thermoset composition comprising a low polarity resin, an oxaphosphorinoxide-containing aromatic compound, which has a UL-94 rating of at least V-1. However, the embodiments reported therein exhibit high Dk of about 3.8 and high Df of about 0.006.

Therefore, there is still a need to develop new insulating materials that exhibit not only low dielectric properties, very high thermal properties but also good fire retardant properties.

In addition, there is also a need to develop materials, which can form thermoset films rather than thermoplastic films. That is, the thermosets are generally cross-linked structures, which are more stable to higher temperatures and do not exhibit any thermal mobility unlike thermoplastics.

Accordingly, it is an object of this invention to provide a fire retardant composition exhibiting a UL-94 rating of V-0 and excellent dielectric and thermal properties, which contains a polymer having one or more monomers of substituted norbornenes, one of which monomer may contain a free olefinic functionality, an organophosphorus compound and optionally hexagonal boron nitride, which can be formed into an insulating material having hitherto unattainable properties.

Other objects and further scope of the applicability of the present invention will become apparent from the detailed description that follows.

### SUMMARY OF THE INVENTION

Surprisingly, it has now been found that employing a composition that contains a polymer having one or more polycyclic olefinic monomers of formula (I) and optionally a monomer of formula (II) as described herein, one or more organophosphorus compounds of formulae (III) or (IV) as described herein, and optionally hexagonal boron nitride in combination with certain other components as described herein, it is now possible to form a variety of three-dimensional objects, including films, which provide hitherto unattainable dielectric as well as thermal properties.

In another embodiment there is also provided a film forming composition that contains a polymer having two or more polycyclic olefinic monomers of formulae (I) and (II) as described herein, one or more organophosphorus compounds of formulae (III) or (IV) and optionally hexagonal boron nitride in combination with certain other components as described herein can be formed into films suitable as insulating materials that exhibit excellent fire retardant properties.

In another aspect of this invention there is also provided a film, a composite, a prepreg comprising the compositions of this invention.

### BRIEF DESCRIPTION OF THE DRAWINGS

Embodiments in accordance with the present invention are described below with reference to the following accompanying figures and/or images. Where drawings are provided, it will be drawings which are simplified portions of various embodiments of this invention and are provided for illustrative purposes only.

FIG. 1 shows a graphical plot of dielectric reliability studies at a storage temperature of 125° C. over a period of over 1000 hours of an exemplary film formed from the composition of this invention, which is compared with a comparative composition.

FIG. 2 shows a graphical plot of dielectric reliability studies at a storage temperature of 125° C. over a period of over 1000 hours of an exemplary film formed from the composition of this invention, which is compared with storage of another film formed from the same composition at 85° C. and 85 percent relative humidity.

FIG. 3 shows a graphical plot of dielectric reliability studies at a storage temperature of 85° C. and 85 percent relative humidity over a period of over 1000 hours of several exemplary films formed from various composition embodiments of this invention.

### DETAILED DESCRIPTION OF THE INVENTION

The terms as used herein have the following meanings:

As used herein, the articles “a,” “an,” and “the” include plural referents unless otherwise expressly and unequivocally limited to one referent.

Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the term “about.”

Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

As used herein, “hydrocarbyl” refers to a group that contains carbon and hydrogen atoms, non-limiting examples being alkyl, cycloalkyl, aryl, aralkyl, alkaryl, and alkenyl. The term “halohydrocarbyl” refers to a hydrocarbyl group where at least one hydrogen has been replaced by a halogen. The term perhalocarbyl refers to a hydrocarbyl group where all hydrogens have been replaced by a halogen.

As used herein, the expression “alkyl” means a saturated, straight-chain or branched-chain hydrocarbon substituent having the specified number of carbon atoms. Particular alkyl groups are methyl, ethyl, n-propyl, isopropyl, tert-butyl, and so on. Derived expressions such as “alkoxy,” “thioalkyl,” “alkoxyalkyl,” “hydroxyalkyl,” “alkylcarbonyl,” “alkoxycarbonylalkyl,” “alkoxycarbonyl,” “diphenylalkyl,” “phenylalkyl,” “phenylcarboxyalkyl” and “phenoxyalkyl” are to be construed accordingly.

As used herein, the expression “cycloalkyl” includes all of the known cyclic groups. Representative examples of “cycloalkyl” includes without any limitation cyclopropyl, cyclobutyl, cyclopentyl, cyclohexyl, cycloheptyl, cyclooctyl, and the like. Derived expressions such as “cycloalkoxy,” “cycloalkylalkyl,” “cycloalkylaryl,” “cycloalkylcarbonyl” are to be construed accordingly.

As used herein, the expression “perhaloalkyl” represents the alkyl, as defined above, wherein all of the hydrogen atoms in said alkyl group are replaced with halogen atoms selected from fluorine, chlorine, bromine, or iodine. Illustrative examples include trifluoromethyl, trichloromethyl, tribromomethyl, triiodomethyl, pentafluoroethyl, pentachloroethyl, pentabromoethyl, pentaiodoethyl, and straight-chained or branched heptafluoropropyl, heptachloropropyl, heptabromopropyl, nonafluorobutyl, nonachlorobutyl, undecafluoropentyl, undecachloropentyl, tridecafluorohexyl, tridecachlorohexyl, and the like. Derived expression, “perhaloalkoxy,” is to be construed accordingly. It should further be noted that certain of the alkyl groups as described herein may partially be fluorinated, that is, only portions of the hydrogen atoms in said alkyl group are replaced with fluorine atoms and shall be construed accordingly.

As used herein the expression “acyl” shall have the same meaning as “alkanoyl,” which can also be represented structurally as “R—CO—,” where R is an “alkyl” as defined herein having the specified number of carbon atoms. Additionally, “alkylcarbonyl” shall mean same as “acyl” as defined herein. Specifically, “(C₁-C₄)acyl” shall mean formyl, acetyl or ethanoyl, propanoyl, n-butanoyl, etc. Derived expressions such as “acyloxy” and “acyloxyalkyl” are to be construed accordingly.

As used herein, the expression “aryl” means substituted or unsubstituted phenyl or naphthyl. Specific examples of substituted phenyl or naphthyl include o-, p-, m-tolyl, 1,2-, 1,3-, 1,4-xylyl, 1-methylnaphthyl, 2-methylnaphthyl, etc. “Substituted phenyl” or “substituted naphthyl” also include any of the possible substituents as further defined herein or one known in the art.

As used herein, the expression “arylalkyl” means that the aryl as defined herein is further attached to alkyl as defined herein. Representative examples include benzyl, phenylethyl, 2-phenylpropyl, 1-naphthylmethyl, 2-naphthylmethyl and the like.

As used herein, the expression “alkenyl” means a non-cyclic, straight, or branched hydrocarbon chain having the specified number of carbon atoms and containing at least one carbon-carbon double bond, and includes ethenyl and straight-chained or branched propenyl, butenyl, pentenyl, hexenyl, and the like. Derived expression, “arylalkenyl” and five membered or six membered “heteroarylalkenyl” is to be construed accordingly. Illustrative examples of such derived expressions include furan-2-ethenyl, phenylethenyl, 4-methoxyphenylethenyl, and the like.

As used herein, the expression “heteroaryl” includes all of the known heteroatom containing aromatic radicals. Representative 5-membered heteroaryl radicals include furanyl, thienyl or thiophenyl, pyrrolyl, isopyrrolyl, pyrazolyl, imidazolyl, oxazolyl, thiazolyl, isothiazolyl, and the like. Representative 6-membered heteroaryl radicals include pyridinyl, pyridazinyl, pyrimidinyl, pyrazinyl, triazinyl, and the like radicals. Representative examples of bicyclic heteroaryl radicals include, benzofuranyl, benzothiophenyl, indolyl, quinolinyl, isoquinolinyl, cinnolyl, benzimidazolyl, indazolyl, pyridofuranyl, pyridothienyl, and the like radicals.

As used herein, the expression “heterocycle” includes all of the known reduced heteroatom containing cyclic radicals. Representative 5-membered heterocycle radicals include tetrahydrofuranyl, tetrahydrothiophenyl, pyrrolidinyl, 2-thiazolinyl, tetrahydrothiazolyl, tetrahydrooxazolyl, and the like. Representative 6-membered heterocycle radicals include piperidinyl, piperazinyl, morpholinyl, thiomorpholinyl, and the like. Various other heterocycle radicals include, without limitation, aziridinyl, azepanyl, diazepanyl, diazabicyclo[2.2.1]hept-2-yl, and triazocanyl, and the like.

“Halogen” or “halo” means chloro, fluoro, bromo, and iodo.

In a broad sense, the term “substituted” is contemplated to include all permissible substituents of organic compounds. In a few of the specific embodiments as disclosed herein, the term “substituted” means substituted with one or more substituents independently selected from the group consisting of (C₁-C₆)alkyl, (C₂-C₆)alkenyl, (C₁-C₆)perfluoroalkyl, phenyl, hydroxy, —CO₂H, an ester, an amide, (C₁-C₆)alkoxy, (C₁-C₆)thioalkyl and (C₁-C₆)perfluoroalkoxy. However, any of the other suitable substituents known to one skilled in the art can also be used in these embodiments.

It should be noted that any atom with unsatisfied valences in the text, schemes, examples, and tables herein is assumed to have the appropriate number of hydrogen atom(s) to satisfy such valences.

It will be understood that the terms “dielectric” and “insulating” are used interchangeably herein. Thus, reference to an insulating material or layer is inclusive of a dielectric material or layer and vice versa. Further, as used herein, the term “organic electronic device” will be understood to be inclusive of the term “organic semiconductor device” and the several specific implementations of such devices used, for example, in automotive industry.

As used herein, the dielectric constant (Dk) of a material is the ratio of the charge stored in an insulating material placed between two metallic plates to the charge that can be stored when the insulating material is replaced by vacuum or air. It is also called as electric permittivity or simply permittivity. And, at times referred as relative permittivity, because it is measured relatively from the permittivity of free space.

As used herein, “low-loss” is the dissipation factor (Df), which is a measure of loss-rate of energy of a mode of oscillation (mechanical, electrical, or electromechanical) in a dissipative system. It is the reciprocal of quality factor, which represents the “quality” or durability of oscillation.

As used herein, “B-stage” means a material wherein the reaction between the base polymer and the curing agent/hardener is not complete. That is, such “B-staged” material is in a partially cured stage, and generally free of any solvent used to make the composition containing the base polymer and the curing agent/hardener. Generally, when such “B-staged” material is reheated at elevated temperature, the cross-linking is complete, and the material is fully cured.

As used herein, “prepreg” means a material that is pre-impregnated with a polymeric material which can be either a thermoplastic or a thermoset. Generally, a fibrous material such as glass cloth is pre-impregnated with a polymeric material to form prepregs, which is formed by a “B-stage” process and subsequently cured by reheating at elevated temperature.

By the term “derived” is meant that the polymeric repeating units are polymerized (formed) from, for example, polycyclic norbornene-type monomers in accordance with formulae (I) or (II) wherein the resulting polymers are formed by 2,3 enchainment of norbornene-type monomers as shown below:

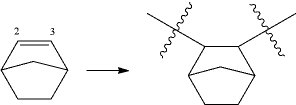

The above polymerization is also known widely as vinyl addition polymerization typically carried out in the presence of organometallic compounds such as organopalladium compounds or organonickel compounds as further described in detail below.

Thus, in accordance with the practice of this invention there is provided a composition comprising:
a) a polymer comprising:
i) at least one first repeating unit represented by formula (IA), said first repeating unit is derived from a monomer of formula (I):

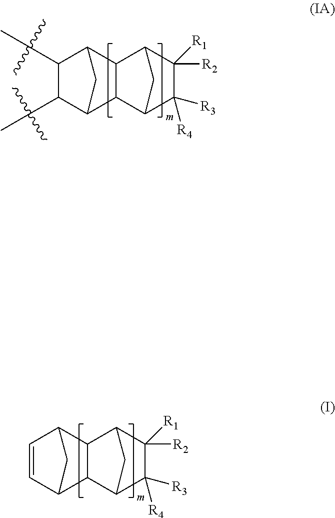

wherein:
[symbol] denotes a place of bonding with another repeat unit;
m is an integer 0, 1 or 2;
R₁, R₂, R₃ and R₄ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
ii) at least one second repeating unit represented by formula (IIA), said second repeating unit is derived from a monomer of formula (II):

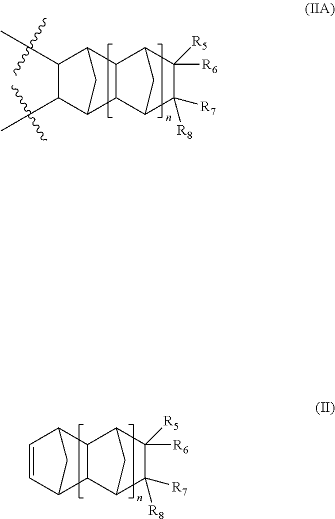

wherein:
[symbol] denotes a place of bonding with another repeat unit;
n is an integer 0, 1 or 2;
at least one of R₅, R₆, R₇ and R₈ is selected from the group consisting of methylidene, ethylidene, vinyl, linear or branched (C₃-C₁₆)alkenyl, (C₃-C₁₀)cycloalkenyl, (C₆-C₁₂)bicycloalkenyl and (C₆-C₁₂)aryl(C₂-C₁₆)alkenyl and the remaining R₅, R₆, R₇ and R₈ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring containing at least one double bond;
and
wherein the second repeat unit is present at an amount in the range of from about zero mole percent to about forty mole percent based on total moles of first and second repeat units;
b) a crosslinking agent selected from the group consisting of:

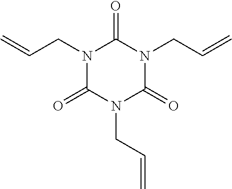 [SMILES: C=CCn1c(=O)n(CC=C)c(=O)n(CC=C)c1=O]

1,3,5-triallyl-1,3,5-triazinane-2,4,6-trione, also known as triallyl isocyanurate (TAIC); and

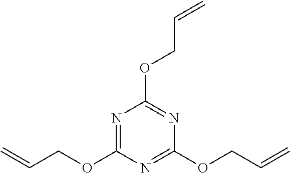 [SMILES: C=CCOc1nc(OCC=C)nc(OCC=C)n1]

2,4,6-tris(allyloxy)-1,3,5-triazine, also known as triallyl cyanurate (TAC);
c) an organophosphorus compound selected from the group consisting of:
a compound of formula (III):

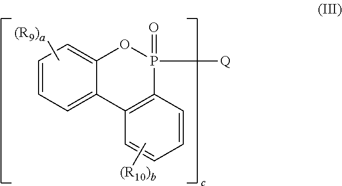

wherein:
each a and b is independently an integer from 0 to 5;
c is an integer from 2 to 4;
Q is selected from the group consisting of a divalent or trivalent (C₂-C₂₄)alkyl, divalent NH(C₂-C₆)alkylNH and divalent O(C₂-C₆)alkylNH, wherein said alkyl is optionally substituted with one or more groups selected from the group consisting of methyl, ethyl, linear or branched (C₃-C₆)alkyl, (C₆-C₁₂)aryl and (C₅-C₁₂)heteroaryl;
each R₉ and R₁₀ is independently selected from the group consisting of hydrogen, methyl, ethyl, and linear or branched (C₃-C₆)alkyl;
a compound of formula (IV):

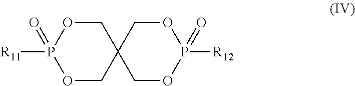

wherein:
each R₁₁ and R₁₂ is independently selected from the group consisting of methyl, ethyl, linear or branched (C₃-C₆)alkyl, phenyl, methoxy, ethoxy, linear or branched (C₃-C₆)alkoxy, phenoxy and 6H-phosphanthridine 5-oxide-(C₁-C₃)alkyl;
d) a tackifier; and
e) one or more additives selected from the group consisting of a free radical initiator, an antioxidant, a synergist and a mixture in any combination thereof.

It should be noted that one or more of the organophosphorus compound of formulae (III) or (IV) is present at an amount greater than 70 weight percent based on the amount of polymer and the composition when formed into a film has a UL-94 rating of at least V-1, a dissipation factor (Df) of less than 0.001 at 10 GHz and a dielectric constant (Dk) of less than 2.5 at 10 GHz.

The polymer as described herein can be prepared by any of the known vinyl addition polymerization in the art. It has now been found that the copolymerization of one or more monomers of formula (I) with one or more monomers of formula (II) it is now possible to form polymers in accordance with this invention where the additional olefinic functionality present in monomer of formula (II) remains unreactive during vinyl addition polymerization and such olefinic functionality remains available in the polymer for other uses. Thus, the polymers of this invention can be used in a variety of applications where further crosslinking with other materials can be carried out. Such methods include formation of prepregs suitable in the fabrication of printed circuit boards, such as copper clad laminates. It has now been found that even incorporation of small amounts of monomer of formula (II) it is now possible to form polymers in accordance with this invention which are quite effective in forming crosslinkable compositions of this invention as described in detail below.

Advantageously, it has now been found that the additional olefinic functionality present in the monomers of formula (II) is not reactive to the vinyl addition polymerization catalyst, and therefore remains present after formation of the polymer in accordance with this invention. That is, one of olefinic groups present in R₅, R₆, R₇ and R₈ of the monomer of formula (II) remains available in the polymer formed in accordance with this invention. Therefore, the polymers of this invention are useful in a variety of applications where there is a need for further reaction involving the olefinic functionality, such as for example, crosslinking with other materials. It has been further observed that the amount of monomer of formula (II) employed can be as little as ten (10) mole percent of the total amount of combined monomers of formulae (I) and (II) in order to observe the crosslinking ability of the polymers of this invention when used in the composition of this invention.

Accordingly, in some embodiments the amount of repeat units of monomer of formula (IIA) present in the polymer is at least ten mole percent based on the total moles of first and second repeat units of formulae (IA) and (IIA). In some other embodiments the amount of repeat units of monomer of formula (IIA) present in the polymer is from about ten mole percent to about forty mole percent, from about fifteen mole percent to about thirty mole percent, from about eighteen mole percent to about twenty-five mole percent, and so on, based on the total moles of first and second repeat units of formulae (IA) and (IIA). In yet some other embodiments the amount of repeat units of monomer of formula (IIA) present in the polymer can be less than ten mole percent depending upon the intended crosslink density as well as it can be more than forty mole percent especially when high crosslink density is required, based on the total moles of first and second repeat units of formulae (IA) and (IIA).

As noted, more than one monomer of formula (I) with at least one monomer of formula (II) can be used to form the polymer of this invention. Advantageously, it has now been found that at least two distinctive monomers of formula (I) are employed with one monomer of formula (II). Again, any desirable amounts of distinctive monomers of formula (I) can be used in combination with a monomer of formula (II) as described herein. In some embodiments such molar ratios of distinctive monomers of formula (I) can be 10:90, 20:80, 30:70, 40:60, 50:50, and so on.

In some embodiments, the polymer employed in the composition according to this invention is having a repeat units of formula (IA) wherein m is 0 or 1. In some other embodiments, the polymer employed in the composition according to this invention is having a repeat units of formula (IA) wherein m is zero. That is, the repeat units of formula (IA) are derived from a monomer of formula (I), which is a derivative of norbornene. Again, one or more distinct monomers of formula (I) can be used to form the polymer of this invention. In some other embodiments the monomer of formula (I) employed is having m equals 1. That is, the monomer employed in this embodiment contains a dimeric norbornene monomer unit, which is also known as tetracyclodecene (TD). However, it should be noted that a combination of monomers of formula (I) having m=0 and m=1 can also be used to form the polymer of this invention. That is, a mixture of norbornene derivatives of formula (I) as described herein can be employed with a suitable tetracyclodecene derivative of formula (I) as described herein can be used to form the polymer of this invention. Again, any suitable amounts of these distinct monomers of formula (I) which will bring about the intended benefit can be employed to form the polymers of this invention. Accordingly, in some embodiments, the polymer according to this invention, encompasses the first repeat unit derived from two distinct monomers of formula (I).

Similarly, in some other embodiments, the polymer employed in the composition according to this invention is having a repeat units of formula (IIA) wherein n is 0 or 1. In some other embodiments, the polymer according to this invention is having a repeat units of formula (IIA) wherein n is zero. That is, the repeat units of formula (IIA) are derived from a monomer of formula (II), which is a derivative of norbornene. Again, one or more distinct monomers of formula (II) can be used to form the polymer of this invention. In some other embodiments the monomer of formula (II) employed is having n equals 1. That is, the monomer employed in this embodiment contains a dimeric norbornene monomer unit, which is also known as tetracyclodecene (TD). However, it should be noted that a combination of monomers of formula (II) having n=0 and n=1 can also be used to form the polymer of this invention. That is, a mixture of norbornene derivatives of formula (II) as described herein can be employed with a suitable tetracyclodecene derivative of formula (II) can be used to form the polymer of this invention. Again, any suitable amounts of these distinct monomers which will bring about the intended benefit can be employed to form the polymers of this invention.

In some embodiments, R₁, R₂, R₃ and R₄ are the same or different and each independently selected from the group consisting of hydrogen, methyl, ethyl, n-propyl, n-butyl, n-hexyl, cyclopentyl, cyclohexyl and norbornyl.

In some other embodiments, one of R₁ and R₂ taken together with one of R₃ and R₄ and the carbon atoms to which they are attached to form a cyclopentyl, cyclohexyl, cycloheptyl, bicycloheptyl, bicyclooctyl, or adamantyl ring.

In yet some other embodiments, at least one of R₅, R₆, R₇ and R₈ is selected from the group consisting of ethylidene, vinyl, propenyl, butenyl, pentenyl, hexenyl, heptenyl, octenyl, cyclopentenyl and cyclohexenyl, and the remaining R₅, R₆, R₇ and R₈ are the same or different and each independently selected from the group consisting of hydrogen, methyl, ethyl, n-propyl, n-butyl, n-hexyl, cyclopentyl, cyclohexyl and norbornyl.

In some embodiments, one of R₅ and R₆ taken together with one of R₇ and R₈ and the carbon atoms to which they are attached to form a cyclopentenyl, cyclohexenyl, cycloheptenyl, bicycloheptenyl or bicyclooctenyl ring.

Again, any of the monomers of formula (I) within the scope of this invention can be employed to form the polymers of this invention. Non-limiting examples of such monomers of formula (I) may be selected from the group consisting of:

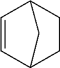

bicyclo[2.2.1]hept-2-ene (norbornene or NB);

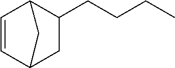

5-butylbicyclo[2.2.1]hept-2-ene (BuNB);

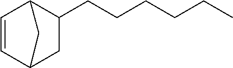

5-hexylbicyclo[2.2.1]hept-2-ene (HexNB);

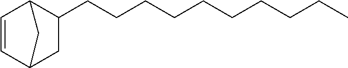 [SMILES: CCCCCCCCCCC1CC2C=CC1C2]

5-decylbicyclo[2.2.1]hept-2-ene (DecNB);

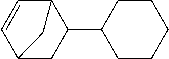 [SMILES: C1=CC2CC1CC2C1CCCCC1]

5-cyclohexylbicyclo[2.2.1]hept-2-ene (CyHexNB);

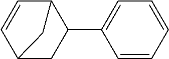 [SMILES: C1=CC2CC1CC2c1ccccc1]

5-phenylbicyclo[2.2.1]hept-2-ene PhNB);

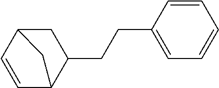 [SMILES: C1=CC2CC1CC2CCc1ccccc1]

5-phenethylbicyclo[2.2.1]hept-2-ene (PENB);

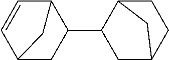 [SMILES: C1=CC2CC1CC2C1CC2CCC1C2]

2,2′-bi(bicyclo[2.2.1]heptan-5-ene) (NBANB);

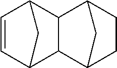 [SMILES: C1=CC2CC1C1C3CCC(C3)C21]

1,2,3,4,4a,5,8,8a-octahydro-1,4:5,8-dimethanonaphthalene (TD); and

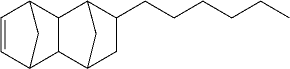 [SMILES: CCCCCCC1CC2CC1C1C3C=CC(C3)C21]

2-hexyl-1,2,3,4,4a,5,8,8a-octahydro-1,4:5,8-dimethanonaphthalene (HexTD).

Similarly, any of the monomers of formula (II) within the scope of this invention can be employed to form the polymers of this invention. Non-limiting examples of such monomers of formula (II) may be selected from the group consisting of:

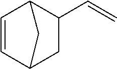

5-vinylbicyclo[2.2.1]hept-2-ene (VNB);

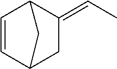

5-ethylidenebicyclo [2.2.1]hept-2-ene (ENB);

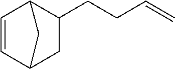

5-(but-3-en-1-yl)bicyclo[2.2.1]hept-2-ene (ButenylNB);

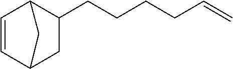

5-(hex-5-en-1-yl)bicyclo[2.2.1]hept-2-ene (HexenylNB);

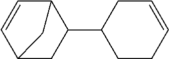 [SMILES: C1=CCC(C2CC3C=CC2C3)CC1]

5-(cyclohex-3-en-1-yl)bicyclo[2.2.1]hept-2-ene (CyclohexeneNB);

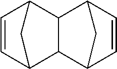 [SMILES: C1=CC2CC1C1C3C=CC(C3)C21]

1,4,4a,5,8,8a-hexahydro-1,4:5,8-dimethanonaphthalene (TDD);

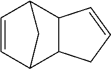

3a,4,7,7a-tetrahydro-1H-4,7-methanoindene (DCPD); and

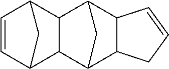 [SMILES: C1=CC2C(C1)C1CC2C2C3C=CC(C3)C12]

3a,4,4a,5,8,8a,9,9a-octahydro-1H-4,9:5,8-dimethanocyclopenta[b]naphthalene (CPD3).

Exemplary non-limiting examples of polymer according to this invention may be enumerated as follows:
a copolymer of norbornene (NB) and 5-vinylbicyclo[2.2.1]hept-2-ene (VNB);
a copolymer of norbornene (NB) and 5-ethylidenebicyclo [2.2.1]hept-2-ene (ENB);
a copolymer of norbornene (NB) and 5-(but-3-en-1-yl)bicyclo[2.2.1]hept-2-ene (ButenylNB);
a copolymer of norbornene (NB) and 5-hex-5-en-1-yl)bicyclo [2.2.1]hept-2-ene (HexenylNB); and
a copolymer of norbornene (NB) and 5-cyclohex-3-en-1-yl)bicyclo[2.2.1]hept-2-ene (CyclohexeneNB);
a terpolymer of norbornene (NB), 5-butylbicyclo[2.2.1]hept-2-ene (BuNB) and 5-(but-3-en-1-yl)bicyclo[2.2.1]hept-2-ene (ButenylNB);
a terpolymer of norbornene (NB), 5-butylbicyclo[2.2.1]hept-2-ene (BuNB) and 5-(cyclohex-3-en-1-yl)bicyclo[2.2.1]hept-2-ene (CyclohexeneNB);
a terpolymer of norbornene (NB), 5-hexylbicyclo[2.2.1]hept-2-ene (HexNB) and 5-(but-3-en-1-yl)bicyclo[2.2.1]hept-2-ene (ButenylNB);
a terpolymer of norbornene (NB), 5-hexylbicyclo[2.2.1]hept-2-ene (HexNB) and 5-(hex-5-en-1-yl)bicyclo[2.2.1]hept-2-ene (HexenylNB); and a terpolymer of norbornene (NB), 5-hexylbicyclo[2.2.1]hept-2-ene (HexNB) and 5-cyclohex-3-en-1-yl)bicyclo[2.2.1]hept-2-ene (CyclohexeneNB).

In another aspect of this invention the polymer employed in the composition of this invention contains only the repeat units of formula (IA) derived from the monomer of formula (I). That is, in this embodiment of the invention the polymer employed does not contain any repeat unit of formula (IIA) which contains a free olefinic functionality. Thus, such polymer is not crosslinkable to form a thermoset composition. Accordingly, there is also provided a thermoplastic composition containing only the repeat units of formula (IA) where there is a need for such composition. Any one or more of the monomers of formula (I) which can form homopolymer, copolymer, terpolymer can be used in this aspect of the composition of this invention.

Exemplary non-limiting examples of polymer according to this aspect of the invention may be enumerated as follows:
a homopolymer of norbornene (NB);
a homopolymer of 5-(butyl)bicyclo[2.2.1]hept-2-ene (BuNB);
a homopolymer of 5-(hexyl)bicyclo[2.2.1]hept-2-ene (HexNB);
a homopolymer of 5-(decyl)bicyclo[2.2.1]hept-2-ene (DecNB);
a copolymer of norbornene (NB) and 5-(butyl)bicyclo [2.2.1]hept-2-ene (BuNB);
a copolymer of norbornene (NB) and 5-hexyl)bicyclo [2.2.1]hept-2-ene (HexNB); and
a copolymer of norbornene (NB) and 5-cyclohexyl)bicyclo[2.2.1]hept-2-ene (CyclohexaneNB);
a terpolymer of norbornene (NB), 5-butylbicyclo[2.2.1]hept-2-ene (BuNB) and 5-(hexyl)bicyclo[2.2.1]hept-2-ene (HexNB);
a terpolymer of norbornene (NB), 5-butylbicyclo[2.2.1]hept-2-ene (BuNB) and 5-(cyclohexyl)bicyclo[2.2.1]hept-2-ene (CyclohexaneNB); and
a terpolymer of norbornene (NB), 5-hexylbicyclo[2.2.1]hept-2-ene (HexNB) and 5-(decyl)bicyclo[2.2.1]hept-2-ene (DecylNB).

As noted, the monomers of formulae (I) and (II) undergo vinyl addition polymerization using any of the suitable catalysts known in the art. For example, various palladium compounds, platinum compounds as well as various nickel compounds have been used to form polymers of the types described herein. In some embodiments of this invention the polymer of this invention is formed by employing a palladium compound. Various palladium compounds known in the art can be employed. Non-limiting examples of such palladium compounds, including a few platinum compounds may be enumerated as follows:
palladium (II) bis(triphenylphosphine) dichloride;
palladium (II) bis(triphenylphosphine) dibromide;
palladium (II) bis(triphenylphosphine) diacetate;
palladium (II) bis(triphenylphosphine) bis(trifluoroacetate);
palladium (II) bis(tricyclohexylphosphine) dichloride;
palladium (II) bis(tricyclohexylphosphine) dibromide;
palladium (II) bis(tricyclohexylphosphine) diacetate (Pd785);
palladium (II) bis(tricyclohexylphosphine) bis(trifluoroacetate);
palladium (II) bis(tri-p-tolylphosphine) dichloride;
palladium (II) bis(tri-p-tolylphosphine) dibromide;
palladium (II) bis(tri-p-tolylphosphine) diacetate;
palladium (II) bis(tri-p-tolylphosphine) bis(trifluoroacetate);
palladium (II) ethyl hexanoate;
bis(acetonato)palladium (II);
dichloro bis(benzonitrile)palladium (II);
n-butyldi-1-adamantylphosphine palladium diacetate(H₂O) (Pd601);
n-butyldi-tert-butylphosphine palladium diacetate(H₂O) (Pd445);
bis(n-butyl-di-1-adamantylphosphine) palladium acetate(acetonitrile) tetrakis(pentafluorophenyl)borate (Pd1602);
(acetonitrile)bis(triisopropylphosphine)palladium(acetate)tetrakis(pentafluorophenyl) borate (Pd1206);
[(allyl)palladium(trinaphthylphosphine)(trifluoroacetate)];
[(allyl)palladium(trinaphthylphosphine)(trifluoromethanesulfonate)];
platinum (II) chloride;
platinum (II) bromide; and
platinum bis(triphenylphosphine)dichloride.

It is also well known in the art that such palladium compounds are further activated using a variety of activator compounds. Non-limiting examples of such activators may be selected from the group consisting of:
lithium tetrafluoroborate;
lithium triflate;
lithium tetrakis(pentafluorophenyl)borate;
lithium tetrakis(pentafluorophenyl)borate etherate (LiFABA);
sodium tetrakis(pentafluorophenyl)borate etherate (NaFABA);
trityl tetrakis(pentafluorophenyl)borate etherate (tritylFABA);
tropylium tetrakis(pentafluorophenyl)borate etherate (tropyliumFABA);
lithium tetrakis(pentafluorophenyl)borate isopropanolate;
lithium tetraphenylborate;
lithium tetrakis(3,5-bis(trifluoromethyl)phenyl)borate;
lithium tetrakis(2-fluorophenyl)borate;
lithium tetrakis(3-fluorophenyl)borate;
lithium tetrakis(4-fluorophenyl)borate;
lithium tetrakis(3,5-difluorophenyl)borate;
lithium hexafluorophosphate;
lithium hexaphenylphosphate;
lithium hexakis(pentafluorophenyl)phosphate;
lithium hexafluoroarsenate;
lithium hexaphenylarsenate;
lithium hexakis(pentafluorophenyl)arsenate;
lithium hexakis(3,5-bis(trifluoromethyl)phenyl)arsenate;
lithium hexafluoroantimonate;
lithium hexaphenylantimonate;
lithium hexakis(pentafluorophenyl)antimonate;
lithium hexakis(3,5-bis(trifluoromethyl)phenyl)antimonate;
lithium tetrakis(pentafluorophenyl)aluminate;
lithium tris(nonafluorobiphenyl)fluoroaluminate;
lithium (octyloxy)tris(pentafluorophenyl)aluminate;
lithium tetrakis(3,5-bis(trifluoromethyl)phenyl)aluminate;
lithium methyltris(pentafluorophenyl)aluminate; and
dimethylanilinium tetrakis(pentafluorophenyl)borate (DANFABA).

Generally, the polymerization is carried out in a suitable solvent and at a suitable temperature. Any of the solvents that can solubilize the palladium compounds and the monomers employed or miscible with the liquid monomers can be employed for this purpose. Suitable polymerization solvents include without any limitation, alkane and cycloalkane solvents, such as pentane, hexane, heptane, decalin, cyclohexane and methyl cyclohexane; halogenated alkane solvents such as dichloromethane, chloroform, carbon tetrachloride, ethylchloride, 1,1-dichloroethane, 1,2-dichloroethane, 1-chloropropane, 2-chloropropane, 1-chlorobutane, 2-chlorobutane, 1-chloro-2-methylpropane, and 1-chloropentane; ethers such as THF and diethylether; aromatic solvents such as benzene, xylene, toluene, mesitylene, chlorobenzene, and o-dichlorobenzene; and halocarbon solvents such as Freon® 112; ester solvents such as methyl acetate, ethyl acetate, butyl acetate and amyl acetate; and mixtures in any combination thereof.

Any of the temperature conditions that will bring about such polymerization can be used herein. In some embodiments, the polymer of this invention is formed by heating a mixture containing suitable amounts of monomers of formulae (I) and (II) in the presence of a palladium compound and the activator as described herein at a temperature in the range of about 60° C. to about 150° C. for a sufficient length of time, for example from about one hour to eight hours. In some other embodiments, the monomer mixture with the catalyst is heated to a temperature of about 90° C. to about 130° C. for a sufficient length of time, for example from about one hour to four hours to form the polymer of this invention. Further, the solution polymerization is carried out under an inert atmosphere, such as for example, under nitrogen, helium or argon atmosphere and using anhydrous solvents.

Advantageously, the vinyl addition polymer is formed from a palladium compound and monomers of formulae (I) and (II) with very high conversion at low (for example 20,000-25,000 to 1) catalyst loading, where the polymer's molecular weight is controlled using a chain transfer agent, such as, triethylsilane (TES). Various other chain transfer agents can also be used to control the molecular weight of the resulting polymer as described herein, including for example, bicyclo[4.2.0]oct-7-ene (BCO), formic acid, various other silanes, and the like, including mixtures in any combination thereof. Use of various CTAs in vinyl addition polymerization in order to control the resulting polymer properties is well known in the art. See, for example, U.S. Pat. No. 9,771,443 B2, pertinent portions of which are incorporated herein by reference.

The polymers formed according to this invention generally exhibit a weight average molecular weight (M_{w}) of at least about 1,000. In another embodiment, the polymer of this invention has a M_{w} of at least about 3,000, 5,000, 10,000 or 20,000. In another embodiment, the polymer of this invention has a M_{w} of at least about 50,000. In another embodiment, the polymer of this invention has a M_{w} of at least about 60,000. In another embodiment, the polymer of this invention has a M_{w} of at least about 70,000. In yet another embodiment, the polymer of this invention has a M_{w} of at least about 80,000. In some other embodiments, the polymer of this invention has a M_{w} of at least about 100,000. In another embodiment, the polymer of this invention has a M_{w} of higher than 150,000, higher than 200,000 and can be higher than 500,000 in some other embodiments. The weight average molecular weight (M_{w}) of the polymer can be determined by any of the known techniques, such as for example, by gel permeation chromatography (GPC) equipped with suitable detector and calibration standards, such as differential refractive index detector calibrated with narrow-distribution polystyrene standards or polybutadiene (PBD) standards. The polymers of this invention typically exhibit polydispersity index (PDI) higher than 3, which is a ratio of weight average molecular weight (M_{w}) to number average molecular weight (Mₙ). In general, the PDI of the polymers of this invention ranges from 3 to 5. In some embodiments the PDI is higher than 3.5, higher than 4, higher than 4.5, or can be higher than 5. However, it should be noted that in some embodiments the PDI can be lower than 3, such as for example, 2.5.

The polymer thus formed is then used to make the compositions as described herein, which is used to produce composite materials having hitherto unattainable properties, such as for example, extremely low coefficient of thermal expansion (CTE), which can be as low as 100 ppm/° K, below 90 ppm/° K, 80 ppm/° K, 50 ppm/° K or lower than 40 ppm/° K. The polymer of this invention also exhibits extremely low dielectric constant as well as low loss properties. For example, dielectric constant (Dk) of the polymer of this invention can be as low as 2.8 or lower and can be in the range of from about 2.2 to about 3.2 at a frequency of 10 GHz. The low loss (Df) of the polymer can be lower than 0.0015, and may range from about 0.001 to 0.002. In addition, the polymer of this invention exhibits extremely high glass transition temperature (T_{g}), which can be higher than 250° C., and generally ranges from about 250° C. to 350° C. Even more importantly, the polymer of this invention readily binds with other crosslinkable materials as illustrated further below in various compositions made according to this invention. The compositions thus formed exhibit excellent peel strength, generally ranging from 2 to 8 N/cm, thus finding many applications for example as copper clad laminates.

Any amount of the polymer as described herein can be used in the composition of this invention which brings about the intended benefit. Generally, such amounts can range from about 20 weight percent to about 80 weight percent based on the total weight of the composition. However, it should be noted that in some embodiments the amount of polymer employed can be lower than 20 weight percent or can be higher than 80 weight percent, all such permissible combination is well within the scope of this invention.

As noted, the composition according to this invention contains at least one crosslinking agent, which can be either TAIC or TAC. In some embodiments the composition according to this invention can contain a mixture of both TAIC and TAC.

Any amount of the crosslinking agents, TAIC or TAC, either taken alone, or in combination, can be used in the composition of this invention so as to bring about the intended benefit. Accordingly, in some embodiments the composition contains only TAIC as the crosslinking agent. In some other embodiments the composition contains only TAC as the crosslinking agent. In yet some other embodiments the composition contains a mixture of both TAIC and TAC as the crosslinking agents. Generally, the amount of TAIC or TAC used alone in the composition of this invention can range from about 5 to 20 parts per hundred parts of polymer (pphr), 8 to 18 pphr, 10 to 16 pphr, and so on. When a combination of TAIC and TAC are used in the composition the amounts of each can be same or different. The total amount of TAIC and TAC may be around 10 to 30 pphr, 15 to 25 pphr, and so on. Again, it should be noted that such amounts can be higher or lower depending upon the intended use of the composition.

Advantageously, it has now been observed that various other crosslinking agents which will bring about similar effect as that of TAIC or TAC can also be used in the composition of this invention. A few of such crosslinking agents include without any limitation 1,2,4-trivinyl cyclohexane, trimethylolpropane triacrylate, trimethylolpropane trimethacrylate, and the like.

As noted, the composition according to this invention further contains at least one organophosphorus compound of formulae (III) or one organophosphorus compound of formulae (IV) or phosphazene.

In some embodiments the composition of this invention contains at least one compound of formula (III), where each a and b is independently 0, 1, 2, 3, 4 or 5. Typically, c is 2 but can be 3 or 4. Q is generally a divalent linking group selected from the group consisting of ethylene, propylene, butylene, pentalene, hexalene, 1,2-diaminoethylene, 1,3-diamino-propylene, —OCH₂NH— and —OCH₂CH₂NH—. Any one of these methylene can be optionally substituted with methyl, ethyl, n-propyl, iso-propyl, n-butyl, iso-butyl, tert-butyl, n-pentyl, n-hexyl, phenyl, biphenyl, naphthyl, furanyl, pyrrolyl, imidazolyl and pyridinyl. Further R₉ and R₁₀ can be selected from the group consisting of methyl, ethyl, n-propyl, iso-propyl, n-butyl, iso-butyl, tert-butyl, n-pentyl and n-hexyl.

Non-limiting examples of such monomers of formula (III) may be selected from the group consisting of:

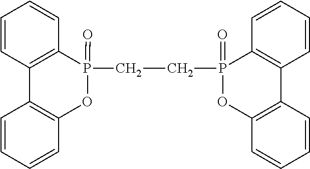 [SMILES: O=P1(CCP2(=O)Oc3ccccc3-c3ccccc32)Oc2ccccc2-c2ccccc21]

6,6′-(ethane-1,2-diyl)bis(dibenzo[c,e][1,2]oxaphosphinine 6-oxide), also known as DiDOPO;

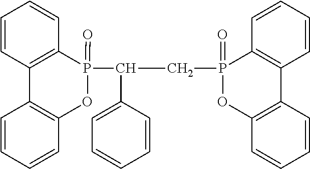 [SMILES: O=P1(CC(c2ccccc2)P2(=O)Oc3ccccc3-c3ccccc32)Oc2ccccc2-c2ccccc21]

6,6′-(1-phenylethane-1,2-diyl)bis(dibenzo[c,e][1,2]oxaphosphinine 6-oxide), also known as DiDOPO2;

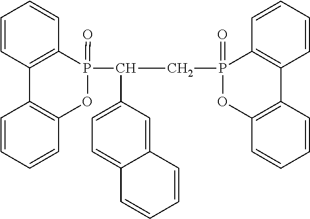 [SMILES: O=P1(CC(c2ccc3ccccc3c2)P2(=O)Oc3ccccc3-c3ccccc32)Oc2ccccc2-c2ccccc21]

6,6′-(1-(naphthalen-2-yl)ethane-1,2-diyl)bis(dibenzo[c,e][1,2]oxaphosphinine 6-oxide), also known as DiDOPO3;

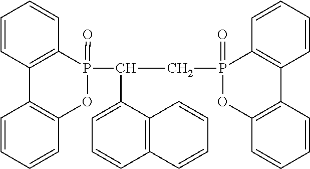 [SMILES: O=P1(CC(c2cccc3ccccc23)P2(=O)Oc3ccccc3-c3ccccc32)Oc2ccccc2-c2ccccc21]

6,6′-(1-(naphthalen-1-yl)ethane-1,2-diyl)bis(dibenzo[c,e][1,2]oxaphosphinine 6-oxide);

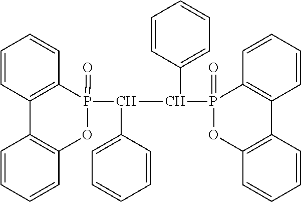 [SMILES: O=P1(C(c2ccccc2)C(c2ccccc2)P2(=O)Oc3ccccc3-c3ccccc32)Oc2ccccc2-c2ccccc21]

6,6′-(1,2-diphenylethane-1,2-diyl)bis(dibenzo[c,e][1,2]oxaphosphinine 6-oxide);

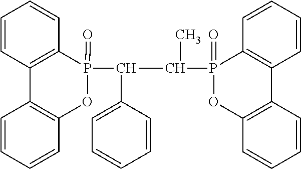 [SMILES: CC(C(c1ccccc1)P1(=O)Oc2ccccc2-c2ccccc21)P1(=O)Oc2ccccc2-c2ccccc21]

6,6′-(1-phenylpropane-1,2-diyl)bis(dibenzo[c,e][1,2]oxaphosphinine 6-oxide);

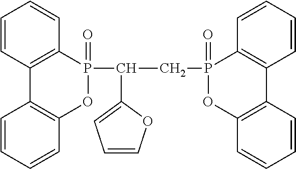 [SMILES: O=P1(CC(c2ccco2)P2(=O)Oc3ccccc3-c3ccccc32)Oc2ccccc2-c2ccccc21]

6,6′-(1-(furan-2-yl)ethane-1,2-diyl)bis(dibenzo[c,e][1,2]oxaphosphinine 6-oxide);

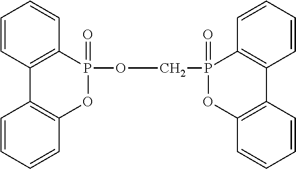 [SMILES: O=P1(COP2(=O)Oc3ccccc3-c3ccccc32)Oc2ccccc2-c2ccccc21]

6-((6-oxidodibenzo[c,e][1,2]oxaphosphinin-6-yl)methoxy)dibenzo[c,e][1,2]oxa-phosphinine 6-oxide, also known as DiDOPOMeO;

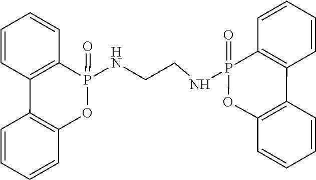 [SMILES: O=P1(NCCNP2(=O)Oc3ccccc3-c3ccccc32)Oc2ccccc2-c2ccccc21]

6,6′-(ethane-1,2-diylbis(azanediyl))bis(dibenzo[c,e][1,2]oxaphosphinine 6-oxide), also known as EDAB-DOPO;

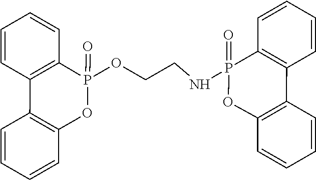 [SMILES: O=P1(NCCOP2(=O)Oc3ccccc3-c3ccccc32)Oc2ccccc2-c2ccccc21]

6-(2-((6-oxidodibenzo[c,e][1,2]oxaphosphinin-6-yl)amino)ethoxy)dibenzo[c,e][1,2]oxaphosphinine 6-oxide, also known as EAB-DOPO.

In some embodiments the composition of this invention contains at least one compound of formula (IV), where R₁₁ and R₁₂ can be selected from the group consisting of methyl, ethyl, n-propyl, iso-propyl, n-butyl, iso-butyl, tert-butyl, n-pentyl, n-hexyl, phenyl, methoxy, ethoxy, n-propoxy, iso-propoxy, n-butoxy, iso-butoxy, tert-butoxy, n-pentyloxy, n-hexyloxy, phenoxy, 6H-phosphanthridine 5-oxide-methyl, 6H-phosphanthridine 5-oxide-ethyl and 6H-phosphanthridine 5-oxide-propyl.

Non-limiting examples of such monomers of formula (IV) may be selected from the group consisting of:

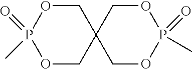

3,9-dimethyl-2,4,8,10-tetraoxa-3,9-diphosphaspiro[5.5]undecane 3,9-dioxide (available commercially as AFLAMMIT® PCO 900 from Thor Flame Retardants);

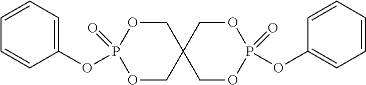 [SMILES: O=P1(Oc2ccccc2)OCC2(CO1)COP(=O)(Oc1ccccc1)OC2]

3,9-diphenoxy-2,4,8,10-tetraoxa-3,9-diphosphaspiro[5.5]undecane 3,9-dioxide (available commercially as AFLAMMIT® PCO 910 from Thor Flame Retardants); and

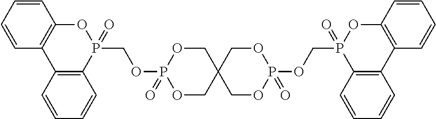 [SMILES: O=P1(OCP2(=O)Oc3ccccc3-c3ccccc32)OCC2(CO1)COP(=O)(OCP1(=O)Oc3ccccc3-c3ccccc31)OC2]

3,9-bis((6-oxidodibenzo[c,e][1,2]oxaphosphinin-6-yl)methoxy)-2,4,8,10-tetraoxa-3,9-diphosphaspiro[5.5]undecane 3,9-dioxide.

In yet some other embodiments the composition of this invention contains phosphazene as the organophosphorus compound.

Any amount of organophosphorus compound can be used which will bring about the intended benefit and depending upon the end application of the composition. For example, by suitable amounts of incorporation of organophosphorus compound into the composition of this invention it is now possible to obtain not only excellent fire retardant property, such as for example UL-94 V-0 rating, but also exhibit excellent dielectric properties and storage stability at temperatures in the range of from about 80° C. to 150° C. and at relative humidity of up to 85 percent.

Accordingly, in some embodiments the amount of organophosphorus compound employed in the composition of this invention is at least 60 weight percent based on the amount of the polymer employed in the composition. That is, 60 parts of organophosphorus compound per 100 parts of polymer used in the composition of this invention, also represented herein as 60 parts per hundred parts resin (pphr). In some other embodiments the amount of organophosphorus compound present in the composition of this invention is at an amount in the range of from about 60 pphr to about 120 pphr. In yet other embodiments such amounts can vary from about 65 pphr to about 110 pphr, from about 70 pphr to about 100 pphr, from about 80 pphr to about 90 pphr, and so on. However, it should be noted that lower than 60 pphr or higher than 120 pphr of organophosphorus compound can also be employed in the composition of this invention where there is such need in fabricating suitable devices. The amount of organophosphorus compound used also depends upon various other components present in the composition which brings about the intended benefit especially the fire retardant property.

Surprisingly, it has now been found that use of hexagonal boron nitride (h-BN) in the composition according to this invention provides such synergistic benefit. That is, it has now been found that by employing h-BN having suitable particle size not only improves high thermal properties needed for various applications but also improves much needed fire retarding properties, among others, such as for example, peel strength when applied to metal substrates such as copper, thus providing exceptional advantage in a variety of applications where copper clad laminates are employed, such as for example, printed circuit boards, mm-Wave Radar Antenna, and the like.

Advantageously it has further been found that the low dielectric properties of the films formed from the composition of this invention can be improved by incorporating h-BN. That is, the compositions of this invention exhibit generally lower dielectric constant (Dk) and lower dissipation factor (Df) when appropriate amount of h-BN is used in the composition of this invention. Generally, the boron nitride employed in the composition of this invention is in the form of hexagonal crystal structure. It is well known in the art that h-BN is available in the form of a powder, which includes flakes, platelets, and other shapes. In some embodiments the h-BN employed in the composition of this invention is in the form of platelets. The exact shape of the platelets is not critical. In this regard, h-BN platelets can have irregular shapes. As used herein, the term “platelets” is generally descriptive of any thin, flattened particles, inclusive of flakes. However, other forms of h-BN can also be used, which include fibers, rods, whiskers, sheets, nanosheets, agglomerates, or boron nitride nanotubes, and can vary as to crystalline type, shape, or size, and including a distribution of the foregoing. The h-BN particles can have an average aspect ratio (the ratio of width or diameter to length of a particle) of 1:2 to 1:100,000, or 1:5 to 1:1,000, or 1:10 to 1:300. Exemplary shapes of particles having particularly high aspect ratios include platelets, rod-like particles, fibers, whiskers, and the like. The platelets can have an average aspect ratio (the ratio of width to length of a particle) of 4:5 to 1:300, or 1:2 to 1:300, or 1:2 to 1:200, or 3:5 to 1:100, or 1:25 to 1:100.

Although the composition of this invention contains hexagonal boron nitride. Other forms of boron nitride can also be used in the composition of this invention, which include cubic, wurtzite, rhombohedral, or other synthetic structure. h-BN has a layered structure, analogous to graphite, in which the layers are stacked in registration such that the hexagonal rings in layers coincide. The positions of N and B atoms alternate from layer to layer. The h-BN particles can be obtained from a variety of commercial sources. Boron nitride particles, crystalline or partially crystalline, can be made by processes known in the art. These include, for example, boron nitride powder produced from the pressing process disclosed in U.S. Pat. Nos. 5,898,009 and 6,048,511, the boron nitride agglomerated powder disclosed in U.S. Patent Publication No. 2005/0041373. A variety of boron nitride powders are commercially available, for example, from St. Gobain.

Generally, the particle size distribution of h-BN can vary significantly and lower the particle size better it is to form homogeneous composition of this invention. Accordingly, in some embodiments the average particle size of h-BN employed is less than 0.05 micrometer (i.e., less than 50 nanometers). In some other embodiments the average particle size of h-BN employed is in the range of from about 0.05 micrometer to about 70 micrometer. In yet some other embodiments the average particle size of h-BN employed is in the range of from about 0.1 micrometer to about 30 micrometer; 0.1 micrometer to about 20 micrometer; 0.1 micrometer to about 20 micrometer, and so on.

Any amount of h-BN can be used which will bring about the intended benefit and depending upon the end application of the composition. For example, by suitable amounts of incorporation of h-BN into the composition of this invention it is now possible to obtain not only excellent dielectric and low loss properties as well as very high thermal properties, including excellent fire retarding property. In addition, it should be noted that h-BN not only acts as an insulating material in various electronic applications but also provides an excellent thermal conductivity and the heat is dissipated faster than the conventional insulating materials, thus composition of this invention are especially suitable for fabricating micro-electronic devices where heat is generated and needs to be dissipated, such as for example mm-Wave Radar Antenna, among others. It is well known in the art that boron nitride has one of the highest thermal conductivity coefficients (751 W/mK at room temperature) among semiconductors and electrical insulators, and its thermal conductivity increases with reduced thickness due to less intra-layer coupling. For comparison, the thermal conductivity of silica particles is around 1.3 W/mK at room temperature. Therefore, depending upon the type of h-BN used and depending upon the amount of h-BN used in the composition of this invention it is now possible to tailor compositions having very high thermal conductivity. The thermal conductivity can be measured by any of the methods known in the art, such as for example, procedures as set forth in ASTM D5470-17, using a TIM Tester 1300.

In some embodiments where h-BN is employed in the composition of this invention the amount of which can be at least 10 weight percent based on the amount of the polymer employed in the composition. In some other embodiments the amount of h-BN present in the composition of this invention is at an amount in the range of from about 15 weight percent to about 120 weight percent based on the amount of the polymer. In yet other embodiments such amounts can vary from about 20 weight percent to about 100 weight percent, from about 30 weight percent to about 80 weight percent, from about 40 weight percent to about 70 weight percent, and so on, based on the amount of the polymer employed in the composition. However, it should be noted that lower than 10 weight percent or higher than 120 weight percent of h-BN, based on the polymer used, can also be employed in the composition of this invention where there is such need in fabricating suitable devices.

It has been further found that when organophosphorus compound of formula (IV) is employed, it may be advantageous to use certain piperidine compounds as synergistic additives to enhance the fire retardant property. Accordingly, in some embodiments there is further employed a compound selected from the group consisting of:
a compound of formula (V):

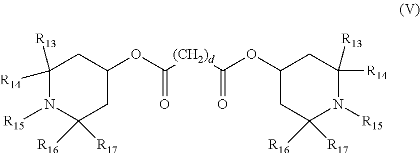

where d is an integer from 6 to 16;
R₁₃, R₁₄, R₁₆, and R₁₇ are the same or different and each independently selected from the group consisting of hydrogen, methyl, ethyl and linear or branched (C₃-C₂₀)alkyl;
R₁₅ is selected from the group consisting of hydrogen, hydroxy, methyl, ethyl, linear or branched (C₃-C₂₀)alkyl, methoxy, ethoxy, linear or branched (C₃-C₂₀)alkoxy and (C₃-C₁₀)cycloalkyl; and
a compound of the formula (VI):

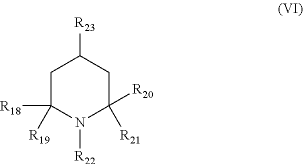

R₁₈, R₁₉, R₂₀, and R₂₁ are the same or different and each independently selected from the group consisting of hydrogen, methyl, ethyl and linear or branched (C₃-C₂₀)alkyl;
R₂₃ is selected from the group consisting of methyl, ethyl, linear or branched (C₃-C₂₀)alkyl, methoxy, ethoxy, linear or branched (C₃-C₂₀)alkoxy, (C₃-C₁₀)cycloalkyl, substituted or unsubstituted (C₃-C₁₀)heterocycle and substituted urea; R₂₂ is selected from the group consisting of methyl, ethyl, linear or branched (C₃-C₂₀)alkyl, methoxy, ethoxy, linear or branched (C₃-C₂₀)alkoxy and (C₃-C₁₀)cycloalkyl.

Exemplary compounds of formula (V) without any limitation may be enumerated as follows:

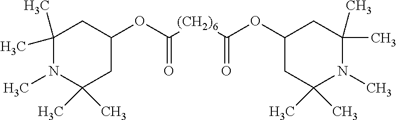

bis(1,2,2,6,6-pentamethylpiperidin-4-yl) octanedioate;

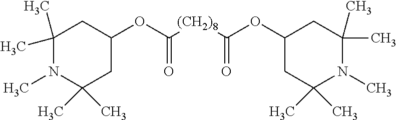

bis(1,2,2,6,6-pentamethylpiperidin-4-yl) sebacate (HALS-1);

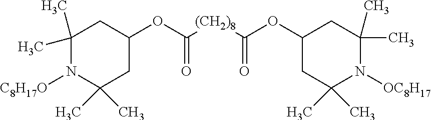

bis(2,2,6,6-tetramethyl-1-(octyloxy)piperidin-4-yl) sebacate (HALS-2);

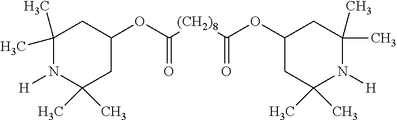

bis(2,2,6,6-tetramethylpiperidin-4-yl) sebacate (HALS-3);

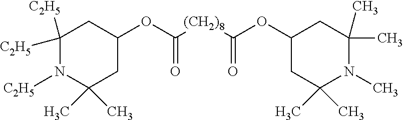

1-(1,2,2,6,6-pentamethylpiperidin-4-yl) 10-(1,2,2-triethyl-6,6-dimethylpiperidin-4-yl) decanedioate;

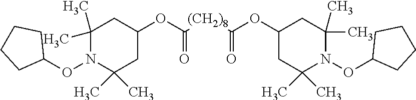

bis(1-(cyclopentyloxy)-2,2,6,6-tetramethylpiperidin-4-yl) decanedioate;

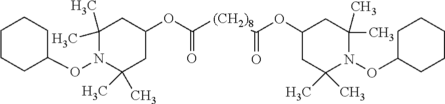

bis(1-(cyclohexyloxy)-2,2,6,6-tetramethylpiperidin-4-yl) decanedioate;

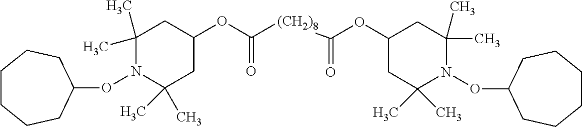

bis(1-(cycloheptyloxy)-2,2,6,6-tetramethylpiperidin-4-yl) decanedioate; and

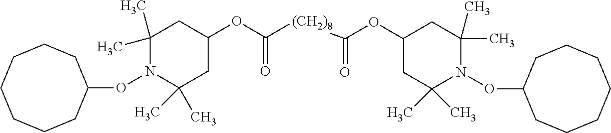

bis(1-(cyclooctyloxy)-2,2,6,6-tetramethylpiperidin-4-yl) decanedioate.

Exemplary compounds of formula (VI) without any limitation may be enumerated as follows:

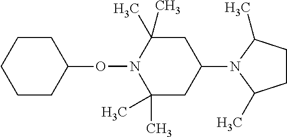 [SMILES: CC1CCC(C)N1C1CC(C)(C)N(OC2CCCCC2)C(C)(C)C1]

1-(cyclohexyloxy)-4-(2,5-dimethylpyrrolidin-1-yl)-2,2,6,6-tetramethylpiperidine; and

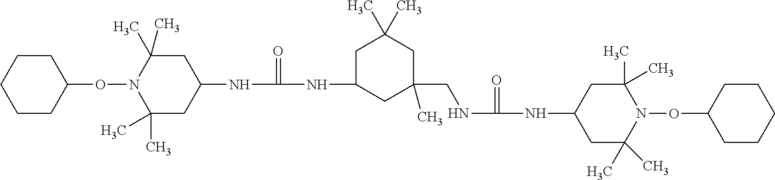 [SMILES: CC1(C)CC(NC(=O)NC2CC(C)(C)N(OC3CCCCC3)C(C)(C)C2)CC(C)(CNC(=O)NC2CC(C)(C)N(OC3CCCCC3)C(C)(C)C2)C1]

1-(1-(cyclohexyloxy)-2,2,6,6-tetramethylpiperidin-4-yl)-3-(3-((3-(1-(cyclohexyloxy)-2,2,6,6-tetramethylpiperidin-4-yl)ureido)methyl)-3,5,5-trimethylcyclohexyl)urea.

It should be noted that other inorganic fillers or organic fillers can also be used in combination with h-BN. Accordingly, in some embodiments, the film forming composition according to this invention comprises an inorganic filler. Suitable inorganic filler is the one which has a coefficient of thermal expansion (CTE) lower than that of the film formed from the composition of this invention. Non-limiting examples of such inorganic filler includes inorganic oxides such as silicon dioxide (silica), aluminum oxide (alumina), diatomaceous earth, titanium oxide, iron oxide, zinc oxide, magnesium oxide, metallic ferrite, germanium oxide, molybdenum oxide, tungsten oxide, zirconium dioxide, yttrium oxide; inorganic carbides such as silicon carbide, boron carbide, aluminum carbide, titanium carbide; inorganic nitrides such as aluminum nitride, silicon nitride, titanium nitride, gallium nitride, boron nitride carbide; inorganic boride such as silicon boride, titanium boride, yttrium boride, iron boride; inorganic sulfide such as gallium sulfide, molybdenum sulfide, tungsten disulfide; inorganic hydroxides such as aluminum hydroxide, zinc hydroxide, silicon hydroxide, magnesium hydroxide; inorganic carbonates such as calcium carbonate (light and heavy), magnesium carbonate, dolomite; inorganic phosphide such as aluminum phosphide, calcium phosphide, iron phosphide, nickel phosphide, iron nickel phosphide; inorganic silicate such as aluminum silicate (SiO₂/Al₂O₁₀), available as montmorilonite (SiO₂/Al₂O₁₀) or Kaolinite (Al₂Si₂O₅(OH)₄), lithium aluminum silicate, available as Lithafrax from St. Gobain; inorganic molybdate, such as zinc molybdate, available as Kemguard; inorganic stannate such as zinc stannate, available as Flamtard; inorganic sulfates such as calcium sulfate, barium sulfate, ammonium sulfate; and calcium sulfite; talc, mica; clay; glass fibers; montmorillonite; silicates such as calcium silicate, bentonite; borates such as zinc borate, barium metaborate, aluminum borate, calcium borate, and sodium borate; carbon black; carbon such as carbon fibers; iron powder; copper powder; aluminum powder; boronic fibers; potassium titanate; and lead zirconate. Various inorganic filler materials are commercially available, for example, silica nano particles are available as SC2300-SVJ from Adamatech Co. Ltd., and a ceramic filler, Lithafrax-2121, is available from St. Gobain, among many other filler materials that may be suitable for using with the composition of this invention.

In some other embodiments the film forming composition according to this invention further comprises an organic filler, which is generally a synthetic resin maybe in the form of a powder or can be in any other suitable form or a polymer. Examples of such polymeric fillers include without any limitation, poly(α-methylstyrene), poly(vinyl-toluene), copolymers of α-methylstyrene and vinyl-toluene, and the like. Further examples of such synthetic resin powder include powders of various thermosetting resins or thermoplastic resins such as alkyd resins, epoxy resins, silicone resins, phenolic resins, polyesters, acrylic and methacrylic resins, acetal resins, polyethylene, polyethers, polycarbonates, polyamides, polysulfones, polystyrenes, polyvinyl chlorides, fluororesins, polypropylene, ethylene-vinyl acetate copolymers, and powders of copolymers of these resins. Other examples of the organic filler include aromatic or aliphatic polyamide fibers, polypropylene fibers, polyester fibers, aramid fibers, and the like.

In some embodiments h-BN is treated with a coupling agent such as for example, silanes, zirconates, titanates, and the like. Exemplary silanes include silane compound having an alkoxysilyl group, an organic functional group such as an alkyl group, an epoxy group, a vinyl group, a phenyl group and a styryl group in one molecule. Such silane compounds include, for example, a silane having an alkyl group such as ethyltriethoxysilane, propyltriethoxysilane or butyltriethoxysilane (alkylsilane), a silane having a phenyl group such as phenyltriethoxysilane, benzyltriethoxysilane or phenethyltriethoxysilane, a silane having a styryl group such as styryltrimethoxysilane, butenyltriethoxysilane, propenyltriethoxysilane or vinyltrimethoxysilane (vinylsilane), a silane having an acrylic or methacrylic group such as γ-(methacryloxypropyl) trimethoxysilane, a silane having an amino group such as γ-aminopropyltriethoxysilane, N-β-(aminoethyl)-γ-aminopropyltrimethoxysilane, N-phenyl-γ-aminopropyltrimethoxysilane or an epoxy group such as γ-(3,4-epoxycyclohexyl) ureido triethoxysilane, and the like. Silanes having a mercapto group such as γ-mercaptopropyltrimethoxysilane or the like can also be used. It should further be noted that one or more of the aforementioned silane compounds can be used in any combination. Other coupling agents include without any limitation vinyltrichlorosilane, trivinylmethoxysilane, vinyltriethoxysilane, vinyltris(β-methoxyethoxy)silane, β-(3,4-epoxycyclohexyl)ethyltris-methoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryl-oxypropyltrimethoxysilane, γ-methacryloxypropylmethyldiethoxysilane, γ-methacryloxy-propyltriethoxysilane, N-β(aminoethyl)γ-aminopropylmethyldimethoxysilane, N-β(amino-ethyl)γ-aminopropyltrimethoxysilane, bis(trimethoxysilylethyl)benzene, bis(triethoxysilyl)-ethylene, triethoxysilyl-modified butadiene, styrylethyltrimethyloxysilane, N-β(aminoethyl)γ-aminopropyltriethoxysilane, γ-aminopropyltrimethoxysilane, γ-aminopropyltriethoxysilane, N-phenyl-γ-aminopropyltrimethoxysilane, trimethoxyphenylsilane, perfluorocotyltriethoxysilane, and γ-mercaptopropyltrimethoxysilane

It should further be noted that, h-BN is generally treated with a “nonpolar silane compound.” Thus, the adhesion between the cyclic olefin polymer used in the composition of this invention and h-BN can be improved. As a result, the mechanical characteristics of the molded body can be improved. Advantageously, it has now been observed that treatment with a “nonpolar silane compound” can eliminate or reduce adverse effects on dielectric properties. As used herein, “nonpolar silane compound” refers to a silane compound having no polar substituent. Polar substituents refer to groups that can be hydrogen-bonded or ionically dissociated. Such polar substituents include, but are not limited to, —OH, —COOH, —COOM, NH₃, NR₄⁺ A⁻, —CONH₂, and the like. Where, M is a cation such as an alkali metal, an alkaline earth metal or a quaternary ammonium salt, R is H or an alkyl group having 8 or less carbon atoms, and A is an anion such as a halogen atom.

In some embodiments, the surface of h-BN is modified with a vinyl group. It is advantageous to employ a vinyl group as it is a non-polar substituent, thus providing much needed low dielectric properties. In order to modify the surface of h-BN with a vinyl group, for example, any one of the specific vinylsilanes listed above can be used.

It has now been observed that by incorporation of h-BN and various other inorganic fillers as described herein it is now possible to reduce the coefficient of thermal expansion (CTE) of the compositions of this invention. Further, heat resistance can be improved. Accordingly, the thermal expansion coefficient can be reduced while the dielectric characteristic is improved. In some embodiments, by employing suitable amounts of h-BN, which can be from about 20 pphr to 80 pphr, the dielectric constant (Dk) of the composition can be as low as 2.4 or lower and low loss (Df) less than about 0.002. In some other embodiments the Dk is in the range of from about 2.4 to about 2.7 and a dielectric dissipation factor (Df) from about 0.0005 to 0.002 at a frequency of 10 GHz.

As noted, the composition according to this invention contains a tackifier. Generally, the purpose of the tackifier is not only to increase the adhesiveness of the composition but also to improve the softness of the composition especially while fabricating at temperatures higher than 130° C. so that the composition may have some flow to impregnate the glass cloth or to fuse with other layers of the device. The composition of this invention can generally be crosslinked at a temperature higher than 130° C., and it is beneficial to keep the composition soft at this temperature. Accordingly, any of the tackifiers that would bring about this benefit can be used in the compositions of this invention. In addition, the amount of tackifier used can also vary depending on the intended use. Generally, such amounts can range from about 5 to 30 parts per hundred parts of polymer (pphr), 8 to 25 pphr, 10 to 20 pphr, and so on. It should be noted that a combination of two or more tackifiers can also be used in the composition of this invention. In such situations the combined amount can be adjusted in order to provide the intended benefit.

Non-limiting examples of such tackifiers that are suitable in the composition of this may be enumerated as follows:

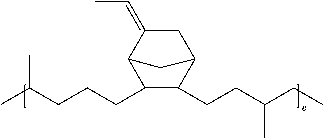

ethylene-propylene-ethylidenenorbornene terpolymer, where e is at least 100 (commercially available as TRILENE® T67 from Lion Elastomers);

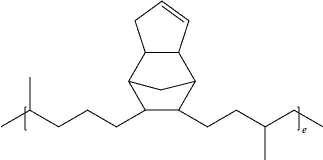

ethylene-propylene-dicyclopentadiene terpolymer, where e is at least 100 (commercially available as TRILENE® T65 from Lion Elastomers);

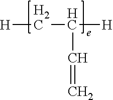

1,2-butadiene rubber, where e is at least 100 (commercially available as B1000 from Nisso America);

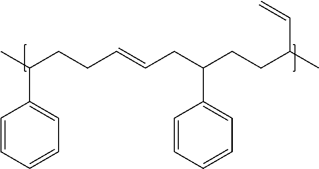

partially hydrogenated styrene/butadiene rubbers 1 (commercially available from Asahi Kasei as Tuftec P1083);

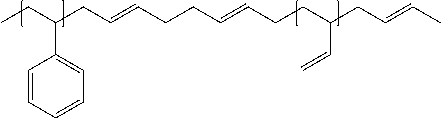

partially hydrogenated styrene/butadiene rubbers 2 (commercially available from Asahi Kasei as Tuftec 1500);

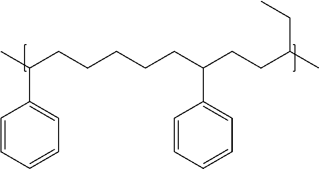

hydrogenated styrene/butadiene rubbers 1 (commercially available from Asahi Kasei as Tuftec H 1052); and

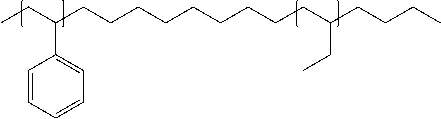

hydrogenated styrene/butadiene rubbers 2.

As noted, the composition of this invention further contains a free radical generator. Any free radical generator which will bring about the crosslinking reaction with the polymer and other components present in the composition and which facilitates adhesion to other suitable substrate such as for example copper and/or glass cloth can be used in the composition of this invention. Again, any amount of free radical generator can be used which will bring about the intended benefit. Such amounts may vary and for example can range from about 1 pphr to 6 pphr of the free radical initiator.

Non-limiting examples of the free radical generator that can be used in the composition of this invention include the following:

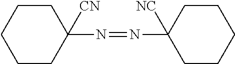 [SMILES: N#CC1(N=NC2(C#N)CCCCC2)CCCCC1]

1,1′-(diazene-1,2-diyl)bis(cyclohexane-1-carbonitrile) (commercially available as V-40 from Sigma Aldrich);

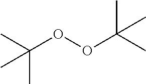

di-tert-butyl peroxide;

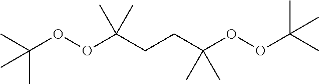 [SMILES: CC(C)(C)OOC(C)(C)CCC(C)(C)OOC(C)(C)C]

2,5-bis(tert-butylperoxy)-2,5-dimethylhexane (Luperox-101);

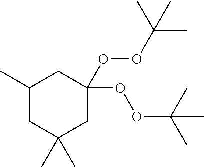 [SMILES: CC1CC(C)(C)CC(OOC(C)(C)C)(OOC(C)(C)C)C1]

1,1-bis(tert-butylperoxy)-3,3,5-trimethylcyclohexane (Luperox-231);

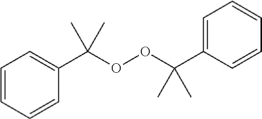 [SMILES: CC(C)(OOC(C)(C)c1ccccc1)c1ccccc1]

dicumyl peroxide (DCP, commercially available from Sigma Aldrich);

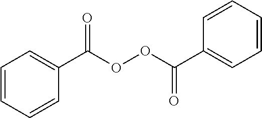 [SMILES: O=C(OOC(=O)c1ccccc1)c1ccccc1]

benzoyl peroxide;

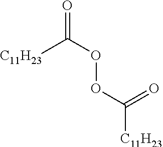

dodecanoic peroxyanhydride (Luperox-LP);

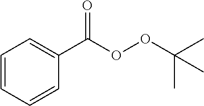

tert-butyl benzoperoxoate (Luperox-P); and

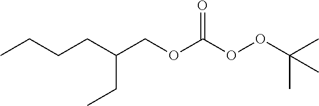 [SMILES: CCCCC(CC)COC(=O)OOC(C)(C)C]

tert-butyl (2-ethylhexyl) carbonoperoxoate (Luperox-TBEC).

As noted, any of the polymers as described herein can be employed in the composition of this invention. Generally, the composition of this invention is dissolved in a suitable solvent to form a homogeneous solution. Such suitable solvents may be the same as the one enumerated above for forming the polymers of this invention. Generally, such solvents to form the composition of this invention include for example, aromatic solvents such as toluene, mesitylene, xylenes, hydrocarbon solvents such as decalin, cyclohexane and methyl cyclohexane, ether solvent such as tetrahydrofuran (THF), ester solvent such as ethyl acetate, and a mixture in any combination thereof.

Non-limiting examples of the composition according to this invention are selected from the group consisting of:
a dispersion containing a mixture of a terpolymer of norbornene (NB), 5-butylbicyclo[2.2.1]hept-2-ene (BuNB) and 5-(but-3-en-1-yl)bicyclo[2.2.1]hept-2-ene (ButenylNB); 1,3,5-triallyl-1,3,5-triazinane-2,4,6-trione (TAIC), 1,2-butadiene rubber (B1000), dicumyl peroxide (DCP) and 6,6′-(ethane-1,2-diyl)bis(dibenzo[c,e][1,2]oxaphosphinine 6-oxide) (DiDOPO);
a dispersion containing a mixture of a terpolymer of norbornene (NB), 5-butylbicyclo[2.2.1]hept-2-ene (BuNB) and 5-(but-3-en-1-yl)bicyclo[2.2.1]hept-2-ene (ButenylNB); 1,3,5-triallyl-1,3,5-triazinane-2,4,6-trione (TAIC), 1,2-butadiene rubber (B1000), poly-aryl ether cross linker end capped with methacrylate groups (SA9000), dicumyl peroxide (DCP) and 6,6′-(ethane-1,2-diyl)bis(dibenzo[c,e][1,2]oxaphosphinine 6-oxide) (DiDOPO);
a dispersion containing a mixture of a terpolymer of norbornene (NB), 5-butylbicyclo[2.2.1]hept-2-ene (BuNB) and 5-(hex-5-en-1-yl)bicyclo[2.2.1]hept-2-ene (HexenylNB); 1,3,5-triallyl-1,3,5-triazinane-2,4,6-trione (TAIC), 1,2-butadiene rubber (B1000), ethylene-propylene-ethylidenenorbornene terpolymer (T67), 3,5-bis(1,1-dimethylethyl)-4-hydroxy-octadecyl ester benzenepropanoic acid (Irganox 1076), tris(2,4-ditert-butylphenyl)phosphite (Irgafos 168), dicumyl peroxide (DCP) and 6,6′-(ethane-1,2-diyl)bis(dibenzo[c,e][1,2]oxaphosphinine 6-oxide) (DiDOPO); and
a dispersion containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber (B1000), ethylene-propylene-ethylidenenorbornene terpolymer (T67), 3,5-bis(1,1-dimethylethyl)4hydroxy-octadecyl ester benzenepropanoic acid (Irganox 1076), tris(2,4-ditert-butylphenyl)phosphite (Irgafos 168), dicumyl peroxide (DCP) and 6,6′-(ethane-1,2-diyl)bis(dibenzo[c,e][1,2]oxaphosphinine 6-oxide) (DiDOPO).

In some other embodiments, the composition of this invention contains h-BN in combination with the organophosphorus compound as described herein. Non-limiting examples of h-BN containing composition according to this invention are selected from the group consisting of:
a dispersion containing a mixture of a terpolymer of norbornene (NB), 5-butylbicyclo[2.2.1]hept-2-ene (BuNB) and 5-(but-3-en-1-yl)bicyclo[2.2.1]hept-2-ene (ButenylNB); 1,3,5-triallyl-1,3,5-triazinane-2,4,6-trione (TAIC), 1,2-butadiene rubber (B1000), dicumyl peroxide (DCP), 6,6′-(ethane-1,2-diyl)bis(dibenzo[c,e][1,2]oxaphosphinine 6-oxide) (DiDOPO) and hexagonal boron nitride (h-BN);
a dispersion containing a mixture of a terpolymer of norbornene (NB), 5-butylbicyclo[2.2.1]hept-2-ene (BuNB) and 5-(but-3-en-1-yl)bicyclo[2.2.1]hept-2-ene (ButenylNB); 1,3,5-triallyl-1,3,5-triazinane-2,4,6-trione (TAIC), 1,2-butadiene rubber (B1000), poly-aryl ether cross linker end capped with methacrylate groups (SA9000), dicumyl peroxide (DCP), 6,6′-(ethane-1,2-diyl)bis(dibenzo[c,e][1,2]oxaphosphinine 6-oxide) (DiDOPO) and hexagonal boron nitride (h-BN);
a dispersion containing a mixture of a terpolymer of norbornene (NB), 5-butylbicyclo[2.2.1]hept-2-ene (BuNB) and 5-(hex-5-en-1-yl)bicyclo[2.2.1]hept-2-ene (HexenylNB); 1,3,5-triallyl-1,3,5-triazinane-2,4,6-trione (TAIC), 1,2-butadiene rubber (B1000), ethylene-propylene-ethylidenenorbornene terpolymer (T67), 3,5-bis(1,1-dimethylethyl)-4-hydroxy-1-octadecyl ester benzenepropanoic acid (Irganox 1076), tris(2,4-ditert-butylphenyl)phosphite (Irgafos 168), dicumyl peroxide (DCP), 6,6′-(ethane-1,2-diyl)bis(dibenzo[c,e][1,2]oxaphosphinine 6-oxide) (DiDOPO) and hexagonal boron nitride (h-BN); and
a dispersion containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber (B1000), ethylene-propylene-ethylidenenorbornene terpolymer (T67), 3,5-bis(1,1-dimethylethyl)-4-hydroxy-octadecyl ester benzenepropanoic acid (Irganox 1076), tris(2,4-ditert-butylphenyl)phosphite (Irgafos 168), dicumyl peroxide (DCP), 6,6′-(ethane-1,2-diyl)bis(dibenzo[c,e][1,2]oxaphosphinine 6-oxide) (DiDOPO) and hexagonal boron nitride (h-BN).

In general, the composition in accordance with the present invention encompass a polymer as described herein containing one or more distinct monomers of formula (I), and optionally at least one monomer of formula (II) in small quantities, as it will be seen below, various composition embodiments are selected to provide properties to such embodiments that are appropriate and desirable for the use for which such embodiments are directed, thus, such embodiments are tailorable to a variety of specific applications. Accordingly, in some embodiments the composition of this invention encompasses a polymer containing more than two distinct monomers of formula (I), such as for example, three different monomers of formula (I) or four different monomers of formula (I) along with any desirable amount of monomer of formula (II), which can be as low as four mole percent as noted above. Also, as noted in some embodiments only one or more monomers of formula (I) are employed.

For example, as already discussed above, by employing proper combination of different monomers of formula (I) it is now possible to tailor a composition having the desirable low dielectric properties and thermo-mechanical properties, among other properties. In addition, it may be desirable to include other polymeric or monomeric materials which are compatible to provide desirable low-loss and low dielectric properties depending upon the end use application as further discussed in detail below.

Even more advantageously, it has now been found that employing at least one monomer of formula (II), surprisingly, even in small amounts it is now possible to form crosslink structures within the polymeric framework in combination with the crosslinking agent as described herein. That is, crosslinks can occur inter-molecular (i.e., between two cross-linkable sites on different polymer chains as well as intra-molecular (i.e., between two cross-linkable sites on the same polymer chain). Statistically, this can happen, and all such combinations are part of this invention. By forming such inter-molecular or intra-molecular crosslinks the polymers formed from the composition of this invention provide hitherto unobtainable properties. This may include for example improved thermal properties. That is, much higher glass transition temperatures than observed for non-crosslinked polymers of similar composition. In addition, such crosslinked polymers are more stable at higher temperatures, which can be higher than 350° C. High temperature stability can also be measured by well-known thermogravimetric analysis (TGA) methods known in the art. One such measurement includes a temperature at which the polymer loses five percent of its weight (T_{d5}). As will be seen below by specific examples that follow the T_{d5} of the polymers formed from the composition of this invention can generally be in the range from about 330° C. to about 420° C. or higher. In some embodiments, the T_{d5} of the polymers formed from the composition of this invention is in the range from about 360° C. to about 400° C.

The compositions in accordance with the present invention may further contain optional additives as may be useful for the purpose of improving properties of both the composition and the resulting object made therefrom. Such optional additives for example may include anti-oxidants and synergists. Any of the anti-oxidants that would bring about the intended benefit can be used in the compositions of this invention. Non-limiting examples of such antioxidants include pentaerythritol tetrakis(3-(3,5-di-tert-butyl-4-hydroxyphenyl)propionate) (IRGANOX™ 1010 from BASF), 3,5-bis(1,1-dimethylethyl)-4-hydroxy-octadecyl ester benzenepropanoic acid (IRGANOX™ 1076 from BASF) and thiodiethylene bis[3-(3,5-di-tert.-butyl-4-hydroxy-phenyl)propionate] (IRGANOX™ 1035 from BASF). Non-limiting examples of such synergists include certain of the secondary antioxidants which may provide additional benefits such as for example prevention of autoxidation and thereby degradation of the composition of this invention and extending the performance of primary antioxidants, among other benefits. Examples of such synergists include, tris(2,4-ditert-butylphenyl)phosphite, commercially available as IRGAFOS 168 from BASF, various diamine synergists such as for example, N,N′-di-2-naphthyl-1,4-phenylenediamine, among others. Another synergist which may be suitable as an additive in the composition of this include certain diesters, such as for example, didodecyl 3,3′-thiodipropionate, whose structure is shown below:

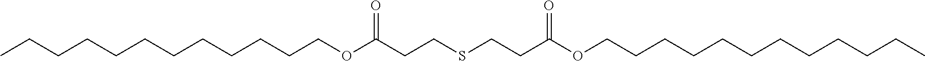 [SMILES: CCCCCCCCCCCCOC(=O)CCSCCC(=O)OCCCCCCCCCCCC]

### didodecyl 3,3′-thiodipropionate (TDPDLE)

Accordingly, the composition of this invention can be formed into films simply by following any of the known film casting techniques, including, for example, doctor blading, drum rolling, extrusion and/or spin coating, among other known methods. Accordingly, there is further provided a film formed from the composition of this invention. For example, any of the composition of this invention can be doctor-bladed onto a suitable substrate such as for example a glass plate. The coated plate is then heated to suitable temperature in an inert atmosphere to remove any residual solvent. Such temperatures can range from about 80° C. to 150° C. or 120° C. to 140° C. Suitable inert atmosphere can be nitrogen or argon. The heating at these temperatures for sufficient length of time will remove all of the residual solvent, for example a time interval of about 45 minutes to about 75 minutes. This initial stage of film forming is generally called as B-staged films. Under these conditions the film is still soluble in a suitable solvent such as for example THF, and is not fully crosslinked. The B-staged films are then further heated to higher temperature, which can range from about 150° C. to 220° C. or 160° C. to 190° C. in an inert atmosphere for sufficient length of time in order to affect the crosslinking of the film. Generally, such heating is carried out for about 90 minutes to 150 minutes to ensure full crosslinking of the composition, which is confirmed by insolubility of the polymer film.

The film thus formed in accordance with this invention exhibits unusually low dielectric constant, low loss, low coefficient of thermal expansion (CTE) and high glass transition temperature and more importantly fire retardant properties. In some embodiments the film formed according to this invention exhibits a dielectric constant (Dk) less than 3, less than 2.8, less than 2.6, less than 2.5, less than 2.4, less than 2.3, less than 2.2 at a frequency of 10 GHz, a glass transition temperature (T_{g}) in the range from about 150° C. to 280° C. or higher. In some other embodiments the T_{g} can be higher than 150° C., higher than 200° C., higher than 250° C. In yet some other embodiments the film according to this invention exhibits coefficient of thermal expansion (CTE) in the range of from about 80 ppm/K to 120 ppm/K, and a CTE less than 50 ppm/K when composited with glass cloth. The composition of this invention also exhibit excellent fire retardant property. For example, in some embodiments the film formed from the composition of this invention exhibit UL-94 rating of at least V-1.

In some embodiments the film formed from the composition of this invention contains 6,6′-(ethane-1,2-diyl)bis(dibenzo[c,e][1,2]oxaphosphinine 6-oxide) (DiDOPO) in the amount higher than eighty weight percent, ninety weight percent or higher than hundred weight percent based on the polymer and has a dielectric constant (Dk) less than 2.5 at a frequency of 10 GHz, a dielectric dissipation factor (Df) less than 0.001 and a UL-94 rating of at least V-1. In some other embodiments the film formed according to this invention exhibits a dielectric constant (Dk) in the range of from about 2.4 to about 2.5 and a dielectric dissipation factor (Df) from about 0.0004 to 0.002 at a frequency of 10 GHz and a UL-94 rating of at least V-0. In yet some other embodiments the film formed from the composition of this invention contains 6,6′-(ethane-1,2-diyl)bis(dibenzo[c,e][1,2]oxaphosphinine 6-oxide) (DiDOPO) in the amount higher than hundred weight percent based on the polymer, hexagonal boron nitride in the amount ranging from about weight percent to about seventy five weight percent based on the polymer and has a dielectric constant (Dk) of less than 2.7 at a frequency of 10 GHz, a dielectric dissipation factor (Df) of less than 0.0009 and a UL-94 rating of at least V-0.

The film according to this invention can be formed from any of the specific embodiment of the composition as enumerated hereinabove. In a further aspect of this invention there is also provided a film formed from the composition of this invention.

It should additionally be noted that the crosslinked polymers formed from the composition of this invention may form thermosets thus offering additional advantages especially in certain applications where thermoplastics are not desirable. For example, any of the applications where higher temperatures are involved the thermoplastic polymers become less desirable as such polymeric materials may flow and are not suitable for such high temperature applications. Such applications include millimeter wave radar antennas as contemplated herein, among other applications.

The composition of the present invention may contain components other than those described above. The components other than the above include a coupling agent, a flame retardant, a release agent, an antioxidant, and the like. Non-limiting examples of the coupling agent include, silane coupling agents, such as, vinylsilanes, acrylic and methacrylic silanes, styrylsilanes, isocyanatosilanes, and the like. Adhesion between the composition of this invention and a base material or the like can be improved by using a silane coupling agent.

Various other flame retardant materials can also be used in combination with organophosphorus compounds as described herein. Non-limiting examples of such flame retardant include various other phosphorus-based flame retardants such as trixylenyl phosphate, dixylenyl phosphate, 10-(2,5-dihydroxyphenyl)-10H-9-oxa-10 phosphaphenanthrene-10-oxide, a halogen-based flame retardant such as a brominated epoxy resin, and an inorganic flame retardant such as aluminum hydroxide and magnesium hydroxide.

The composition of this invention may further include one or more compounds or additives having utility as, among other things, adhesion promoter, a surface leveling agent, a synergist, plasticizers, curing accelerators, and the like.

Surprisingly, it has now been found that employing one or more thermal free radical initiator as described herein it is now possible to accelerate the crosslinking of the polymer formed from the composition of this invention, resulting in a crosslinked polymer that exhibits much improved thermal properties. For example, both glass transition temperature (T_{g}) and temperature at which five weight percent weight loss occurs (T_{d5}) of the resulting polymer can be increased. Such increase in T_{g} can be substantial and can range from about 10° C. to 50° C. In some embodiments the T_{g} of the polymer is increased from 20° C. to 40° C. by employing suitable amounts of thermal free radical initiator. Similarly, the T_{d5} of the polymer can also be increased from about 3° C. to 10° C.

It should be noted that the composition of this invention can be formed into any shape or form and not particularly limited to film. Accordingly, in some embodiments the composition of this invention can be formed into a sheet. The thickness of the sheet is not particularly limited, but when the application as a dielectric material is considered, the thickness is, for example, 0.01 to 0.5 mm. In some other embodiments the thickness is from about 0.02 to 0.2 mm. The sheet so formed generally does not substantially flow at room temperature (25° C.). The sheet may be provided on an arbitrary carrier layer or may be provided alone. Examples of the carrier layer include a polyimide film or a glass sheet. Any other known peelable film substrates may be used as the carrier layer.

As described above, the film/sheet formed in accordance with this invention has good dielectric properties and can be tailored based on the types of components employed in the composition of this invention as described herein. In quantitative terms, the relative permittivity, i.e., the dielectric constant (Dk) of the film/sheet at a frequency of from about 10 GHz to 80 GHz is from about 2.4 to 2.7. The dielectric loss tangent (Df) at a frequency of 10 GHz to 80 GHz is from about 0.0004 to 0.0008. As it is apparent from these properties that the composition exhibits excellent dielectric properties even at very high frequencies with a marginal change in Dk/Df, and therefore, the composition of the present invention finds applications in a variety of devices where such low dielectric materials are needed, such as for example the dielectric polymeric layers used in the millimeter wave radar antenna used in automotive applications and various other terminal equipment used in 5G devices, among others. See for example, JP 2018-109090 and JP 2003-216823. An antenna is usually composed of an insulator and a conductor layer (for example, copper foil). The composition or sheet of the present invention can be used as a part or the whole of the insulator. The antenna using the composition or the sheet of the present invention as a part or the whole of the insulator has good high-frequency characteristics and reliability (durability). The use of such materials in printed circuit boards as Cu-clad laminates need high performance thermosets having high glass transition temperatures, low coefficients of thermal expansion (CTE), low Dk/Df, high peel strength on Cu and good reliability at high temperature storage. The ability to form prepreg (composite with glass cloth), B-staging capability (generate a layer of material that is not cross linked or partially cross linked) and film fusing capability for fabricating layered structures are also important. Most commercial materials available in this area have not attained all these properties, especially low Dk/Df and high glass transition temperature.

The conductor layer in the antenna is formed of, for example, a metal having desirable conductivity. A circuit is formed on the conductor layer by using a known circuit processing method. Conductors forming the conductor layer include various metals having conductivity, such as gold, silver, copper, iron, nickel, aluminum, or alloy metals thereof. As a method for forming the conductor layer, a known method can be used. Examples include vapor deposition, electroless plating, and electrolytic plating. Alternatively, the metal foil (for example, copper foil) may be pressure-bonded by thermocompression bonding. The metal foil constituting the conductor layer is generally a metal foil used for electrical connection. In addition to the copper foil, various metal foils such as gold, silver, nickel, and aluminum can be used. It may also comprise an alloy foil substantially (for example, 98 wt % or more) composed of these metals. Among these metal foils, a copper foil is commonly used. The copper foil may be either a rolled copper foil or an electrolytic copper foil.

Advantageously, the composition of this invention fills the gap not hitherto attainable by the prior art materials. That is, as noted above, the compositions of this invention not only exhibit much needed low Dk/Df properties but also provides very high thermally stable materials as demonstrated by very high T_{g} and very high T_{d5} properties as discussed hereinabove.

Even more importantly the compositions of this invention can be formed into films/sheets of desirable thickness for forming various prepregs with glass cloth for fabricating into copper clad laminates. In some embodiments the film thickness of the films formed from the composition of this invention can be in the range of from about 75 to 150 microns, 90 to 120 microns suitable for forming metal clad laminates. In some embodiments the thickness can be lower than 75 microns or higher than 150 microns.

It should further be noted that various dielectric materials used in the applications mentioned herein must also withstand very harsh temperature conditions and must retain their dielectric properties for a long duration of time. Surprisingly, the films formed in accordance with this invention retain such low dielectric properties for a long period of time of up to 1000 hours or longer even when kept at high temperatures of about 125° C. or higher, thus providing additional benefit. The change of Dk or Df is very low, which can be as low as 3 percent or as low as one percent. Accordingly, in some embodiments of this invention the films formed in accordance with this invention retain substantially their Dk/Df properties for a period of 1000 hours or more at a temperature in the range of about 120° C. to 150° C. or higher.

As noted, the composition of this invention is generally used as such to form a film or sheet. In addition, the composition of this invention can also be used as a low molecular weight varnish-type material for certain applications. The weight average molecular weight of the polymer used in such application can be as low as 1,000 or 2,000 or 3,000 or can be less than 10,000. In such applications suitable amount of the desirable solvents can be added so as to maintain the solid content of the composition to about 10 to 70 weight percent when polymerized. Again, any of the solvents that are suitable to form such solutions can be used as a single solvent or a mixture of solvents as is needed for such application.

In a further aspect of this invention there is provided a kit for forming a film. There is dispensed in this kit a composition of this invention. Accordingly, in some embodiments there is provided a kit in which there is dispensed a polymer as described herein, one or more crosslinking agents as described herein, suitable amounts of h-BN, a tackifier, a free radical generator as described herein; and one or more optional additives as described herein. In some embodiments the kit of this invention contains a polymer having two distinct monomers of formula (I) and a monomer of formula (II) in combination with at least one each of a crosslinking agent, one of a fire retardant compound of formula (III) or (IV) optionally in combination with one or more compounds of formulae (V) or (VI), optionally h-BN, a tackifier as described herein, free radical generator and an optional additive so as to obtain a desirable result and/or for intended purpose.

In another aspect of this embodiment of this invention the kit of this invention forms B-stageable film when subjected to suitable temperature for a sufficient length of time. That is to say that the composition of this invention is poured onto a surface or onto a substrate which needs to be encapsulated and exposed to suitable thermal treatment in order for the composition to form a crosslinked solid material which could be in the form of a film, or a sheet as described herein.

Generally, as already noted above, such crosslinking is performed in stages, first heating to a temperature lower than 150° C. for sufficient length of time, for example 5 minutes to 2 hours at each temperature stage to form a partially crosslinked solvent free B-stage film/sheet. The B-staged film can then be further heated to higher than 150° C. for example temperatures up to 190° C. or higher for various lengths of time such as from 90 minutes to 150 minutes so as to cure the film to form a fully crosslinked polymeric network. By practice of this invention, it is now possible to obtain polymeric films on such substrates which are substantially uniform films. The thickness of the film can be as desired and as specifically noted above, and may generally be in the range of 50 to 500 microns or higher.

While making a sheet and to secure the flatness of the sheet and suppressing unintended shrinkage, various heating methods known to make sheet materials may be employed. For example, it is possible to heat at a relatively low temperature at first, and then gradually raise the temperature. In order to ensure flatness or the like, heating may be performed by pressurizing with a flat plate (metal plate) or the like before heating and/or by pressurizing with a flat plate. The pressure used for such pressurization may be, for example, 0.1 to 8 MPa, and in some other embodiments it may range from about 0.3 to 5 MPa.

In some embodiments, the kit as described herein encompasses various exemplary compositions as described hereinabove.

In yet another aspect of this invention there is further provided a method of forming a film for the fabrication of a variety of optoelectronic and/or automotive devices comprising:
forming a homogeneous clear composition comprising a polymer as described herein; suitable amounts of one or more fire retardant material of formulae (III) or (IV); optionally one or more compounds of formulae (V) or (VI), suitable amounts of h-BN, if needed; one or more crosslinking agent as described herein; a tackifier as described herein; a free radical initiator as described herein; and optionally one or more additives, including a filler as described herein;
coating a suitable substrate with the composition or pouring the composition onto a suitable substrate to form a film; and
heating the film in stages to a suitable temperature to cause formation of the B-stageable film and then a cured film.

The coating of the desired substrate to form a film with the composition of this invention can be performed by any of the coating procedures as described herein and/or known to one skilled in the art, such as by spin coating. Other suitable coating methods include without any limitation spraying, doctor blading, meniscus coating, ink jet coating and slot coating. Other methods of coating also includes chemical vapor deposition depending upon the type of materials that is being coated. The mixture can also be poured onto a substrate to form a film. Suitable substrates include any appropriate substrate as is, or may be used for electrical, electronic, or optoelectronic devices, for example, a semiconductor substrate, a ceramic substrate, a glass substrate.

Next, the coated substrate is baked, i.e., heated to facilitate the removal of solvent and cross linking, for example to a temperature from 50° C. to 150° C. for about 1 to 180 minutes, although other appropriate temperatures and times can be used. That is, first forming the film by a B-stage process to remove any solvent present and then partially curing, and in a subsequent step at a higher temperature fully curing. In some embodiments the substrate is baked at a temperature of from about 100° C. to about 120° C. for 120 minutes to 180 minutes. In some other embodiments the substrate is baked at a temperature of from about 110° C. to about 140° C. for 60 minutes to 120 minutes. That is, these are the B-staged films. Finally, the B-staged films thus formed are further heated to temperatures higher than about 150° C. to fully cure the film.

The films thus formed are then evaluated for their electrical properties using any of the methods known in the art. For example, the dielectric constant (Dk) or permittivity and dielectric loss tangent at a frequency of 10 GHz was measured using a device for measuring the permittivity by the cavity resonator method (manufactured by AET, conforming to JIS C 2565 standard). The coefficient of thermal expansion (CTE) was measured using a thermomechanical analysis apparatus (for example, Seiko Instruments, SS 6000 or Mettler Toledo, TMA/STDA 2+STAR system) in accordance with a measurement sample size of about 4 mm (width)×40 mm (Length)×0.1 mm (thickness), a measurement temperature range of 30-350° C., and a temperature rising rate of 5° C./min. The coefficient of linear expansion from 50° C. to 100° C. was adopted as the coefficient of linear expansion. Generally, the films formed according to this invention exhibit excellent dielectric and thermal properties and can be tailored to desirable dielectric and thermal properties as described herein.

Accordingly, in some of the embodiments of this invention there is also provided a film or sheet obtained by the composition as described herein. In another embodiment there is also provided an electronic device comprising the film/sheet of this invention as described herein.

The composition of this invention can also be formed into a variety of composite structures which can be used as prepreg materials in the fabrication of metal clad laminates. Various types of metals can be used for this purpose, including for example copper, aluminum, stainless steel, among others. Metal clad lamination is well known in the art where layers of metal are cladded with insulation materials, such as for example the composition of this invention. For example, the compositions of this invention can be impregnated onto a glass fabric and then formed into a prepreg in a B-stage process by heating to suitable temperatures as described herein. Then the prepregs thus formed are sandwiched between layers of copper or other metal foil and cured at a temperature higher than 150° C. to form copper clad laminates. It should be noted that various other materials which can be used in place of glass fabric as familiar to one of skill in the art can also be used in this invention. Such other commonly used materials generally in the form of a fabric include without any limitation polyimide cloth/fabric, polybenzimidazole (PBI) cloth/fabric, and the like.

It has now been found that the laminates thus formed in accordance with this invention exhibits excellent peel strength. That is, the cured films of this invention are so strongly bonded to either the glass surface or the metal surface it is difficult to peel the film from such substrates. Even more advantageously, it has now been surprisingly found that the peel strength can be increased by using optimum levels of the free radical initiator. For example, use of very low levels, i.e., less than 0.5 pphr of the free radical initiator can result in the composition exhibiting unacceptable peel strength. Whereas, use of free radical initiator in the range of about 2 to 3 pphr can provide surprisingly excellent peel strength. Accordingly, in some embodiments the peel strength of the composites formed in accordance with this invention can range from about 5 N/cm to about 8 N/cm or 9 N/cm or 11 N/cm or 13 N/cm or even higher depending upon the optimal amounts of free radical initiator used therein and the type of composite that is being made.

Accordingly, in some embodiments there is provided a glass fabric (cloth) composite film/cloth (i.e., a prepreg) formed from the composition of this invention containing one or more organophosphorus compounds of formulae (III) or (IV), which exhibits a dielectric constant (Dk) less than 2.8, generally in the range of from about 2.4 to about 2.5 at a frequency of 10 GHz, a dielectric dissipation factor (Df) less than 0.002, generally in the range of from about 0.001 to 0.0009 at a frequency of 10 GHz and a UL-94 rating of at least V-0, a glass transition temperature higher than 250° C. and the temperature at which 5 percent weight loss occurs is higher than 380° C., a coefficient of thermal expansion (CTE) less than 40 ppm/K and excellent peel strength. In some other embodiments the glass fabric composite of this invention exhibits a dielectric constant (Dk) in the range of from about 2.4 to about 2.45 and a dielectric dissipation factor (Df) of about 0.0009 at a frequency of 10 GHz.

In some other embodiments there is provided a glass fabric (cloth) composite film/cloth (i.e., a prepreg) formed from the composition of this invention containing one or more organophosphorus compounds of formulae (III) or (IV) and h-BN, which exhibits a dielectric constant (Dk) in the range of from about 2.5 to about 2.7 and a dielectric dissipation factor (Df) from about 0.001 to 0.0008 at a frequency of 10 GHz and a UL-94 rating of at least V-0.

Advantageously, it has been further observed that the compositions of this invention can be coated uniformly onto a variety of glass or metal surfaces before curing such that any voids in the surface of such materials are fully covered. Then the coated surface is cured at a higher temperature to form a fully cured insulating layer, which is firmly bonded to such glass or metal surface. That is, for example, it is now possible to provide a metal foil with a coating of this composition to produce a printed wiring board or metal clad laminate in which the adhesion property between the insulating layer (i.e., the film formed from the composition of this invention), and the metal layer is excellent, and the loss at the time of signal transmission is further reduced.

Even more advantageously, it has now been found that the composition of this invention when applied onto a suitable surface can still flow and fill the voids before the two layers are well bonded. This is especially advantageous in the fabrication of metal clad laminates such as copper clad laminates where it is essential that all voids are completely insulated so as to further minimize loss at the time of signal transmission. Accordingly, in one aspect of this invention there is provided a method for producing a prepreg or a metal-clad laminate where a suitable glass fabric or a metal foil is coated with a composition of this invention and heated to suitable temperature in the range of from about 80° C. to 120° C. to form an uncured film of the composition of this invention on such glass fabric and/or metal foil. The composites thus formed are then cured at a higher temperature in the range of from about 160° C. to 180° C. to form fully cured laminates. It should particularly be noted that the polymers used in this aspect of the invention can be of very low molecular weight. That is, the weight average molecular weight (M_{w}) of the polymers employed in this aspect of the invention can be as low as 1,000 or can be in the range from about 1,000 to 5,000. The compositions of this invention exhibit excellent flow properties before they are fully cured and fill the surfaces uniformly on such glass fabric or metal foil, thus providing excellent insulating layer exhibiting very low dielectric constant and low loss properties as described herein.

The following examples are detailed descriptions of methods of preparation and use of certain compounds/monomers, polymers, and compositions of the present invention. The detailed preparations fall within the scope of, and serve to exemplify, the more generally described methods of preparation set forth above. The examples are presented for illustrative purposes only, and are not intended as a restriction on the scope of the invention. As used in the examples and throughout the specification the ratio of monomer to catalyst is based on a mole-to-mole basis.

### Examples (General)

The following abbreviations have been used hereinbefore and hereafter in describing some of the compounds, instruments and/or methods employed to illustrate certain of the embodiments of this invention: NB—bicyclo[2.2.1]hept-2-ene; HexNB—5-hexylbicyclo[2.2.1]hept-2-ene; CyHexeneNB—5-(cyclohex-3-en-1-yl)bicyclo[2.2.1]hept-2-ene; Pd601—palladium diacetate diadamantyl-(n-butyl)phosphine(H₂O); Pd1602—[Pd(OAc)(MeCN)(PAd₂-n-Bu)2]B(C₆F₅)₄; LiFABA—lithium tetrakis(pentafluorophenyl)borate diethyl etherate; Red P—red phosphorus; DiDOPO—6,6′-(ethane-1,2-diyl)bis(dibenzo[c,e][1,2]oxaphosphinine 6-oxide); PCO-900—3,9-dimethyl-2,4,8,10-tetraoxa-3,9-diphosphaspiro[5.5]undecane 3,9-dioxide; FCP-796—a mixture of 3,9-dimethyl-2,4,8,10-tetraoxa-3,9-diphosphaspiro[5.5]undecane 3,9-dioxide and substituted 2,2,6,6-tetramethylpiperidine derivative; SPB-100—phosphazene; h-BN—hexagonal boron nitride; TAIC—1,3,5-triallyl-1,3,5-triazinane-2,4,6-trione; DCP—dicumyl peroxide; B1000—1,2-butadiene rubber; T67—ethylene-propylene-ethylidenenorbornene terpolymer; Irganox-1076—3,5-bis(1,1-<dimetlylethyl)-4-hydroxy-octadecyl ester benzenepropanoic acid; Irgafos-168—tris(2,4-ditert-butylphenyl)phosphite; BCO—bicyclo[4.2.0]oct-7-ene; TES—triethylsilane; EA—ethyl acetate; THF—tetrahydrofuran; GPC—gel permeation chromatography; M_{w}—weight average molecular weight; M.—number average molecular weight; PDI—polydispersity index; NMR—nuclear magnetic resonance spectroscopy; DSC—differential scanning calorimetry; TGA—thermogravimetric analysis; TMA—thermomechanical analysis; pphr—parts per hundred parts resin, i.e., the polymer according to this invention and as specifically described hereinbelow.

Various monomers as used herein are either commercially available or can be readily prepared following the procedures as described in U.S. Pat. No. 9,944,818.

### Example 1

### Terpolymer of NB/HexNB/CyHexeneNB (60/20/20 Molar Ratio)

A mixture of NB (113 g, 1200 mmol), HexNB (71.3 g, 400 mmol) CyHexeneNB (69.7 g, 400 mmol), BCO (1.62 g, 15 mmol) and LiFABA (0.26 g, 0.3 mmol) dissolved in anhydrous toluene (972 g) was placed in a suitable reactor flushed with nitrogen. This solution was heated to 80° C. in a nitrogen atmosphere. Pd601 (0.06 g, 0.1 mmol, 1.3 wt. % solution in THF) was added to this solution. The heating of the mixture at 80° C. while stirring was continued for 6 hours. Toluene (1280 g) was added to the reaction mixture. The diluted polymerized mixture was cooled to room temperature and poured in three batches of about 560 g each to excess iso-propanol (about 2500 g each) while stirring rapidly to precipitate the polymer. The liquids were filtered out and the solids were dried in a vacuum oven at 80-90° C. for 20-30 hours to obtain the purified polymer (238 g, 94% yield). GPC (THF): Mₙ=153,470, Mₙ=31,590, PDI=4.9. The monomeric composition of the terpolymer (NB/HexNB/CyHexeneNB) was calculated to be 60/20/20 from ¹³C-NMR (CDCl₃) analysis.

### Example 2

### Terpolymer of NB/HexNB/CyHexeneNB (60/20/20 Molar Ratio)

A mixture of NB (113 g, 1200 mmol), HexNB (71.3 g, 400 mmol) CyHexeneNB (69.7 g, 400 mmol), TES (1.63 g, 14 mmol), anhydrous ethanol (0.21 g, 200 mmol) and LiFABA (0.26 g, 0.3 mmol) dissolved in anhydrous toluene (969 g) was placed in a suitable reactor flushed with nitrogen. This solution was heated to 80° C. in a nitrogen atmosphere. Pd601 (0.06 g, 0.1 mmol, 1.3 wt. % solution in anhydrous THF) was added to this solution. The heating of the mixture at 80° C. while stirring was continued for 6 hours. Toluene was added to the reaction mixture as in Example 1. The diluted polymerized mixture was cooled to room temperature and poured in three batches of about 560 g each to excess isopropanol while stirring rapidly to precipitate the polymer as set forth in Example 1. The liquids were filtered out and the solids were dried in a vacuum oven at 80-90° C. for 20-30 hours to obtain the purified polymer. GPC (THF): M_{w}=174,230, Mₙ=57,360, PDI=3. The monomeric composition of the terpolymer (NB/HexNB/CyHexeneNB) was calculated to be 62/20/18 from ¹³C-NMR (CDCl₃) analysis.

### Example 3

### Terpolymer of NB/HexNB/CyHexeneNB (60/20/20 Molar Ratio)

A mixture of NB (113 g, 1200 mmol), HexNB (71.3 g, 400 mmol) CyHexeneNB (69.7 g, 400 mmol), BCO (1.08 g, 10 mmol) and LiFABA (0.26 g, 0.3 mmol) dissolved in anhydrous toluene (545 g) was placed in a suitable reactor flushed with nitrogen. This solution was heated to 80° C. in a nitrogen atmosphere. Pd1602 (0.16 g, 0.1 mmol, 1.3 wt. % solution in anhydrous EA) was added to this solution. The heating of the mixture at 90° C. while stirring was continued for 6 hours. THF (850 g) was added to the reaction mixture. The diluted polymerized mixture was cooled to room temperature and poured in three batches of about 550 g each to excess iso-propanol (about 2800 g each) while stirring rapidly to precipitate the polymer. The liquids were filtered out and the solids were dried in a vacuum oven at 80-90° C. for 20-30 hours to obtain the purified polymer (164 g, 65% yield). GPC (THF): M_{w}=140,600, Mₙ=44,840, PDI=3.1. The monomeric composition of the terpolymer (NB/HexNB/CyHexeneNB) was calculated to be 62/21/17 from ¹³C-NMR (CDCl₃) analysis.

### Example 4

### Terpolymer of NB/HexNB/HexenylNB (60/20/20 Molar Ratio)

### Preparation of Pre-Composition

The terpolymer of Example 1 (terpolymer of NB/HexNB/CyHexeneNB, 60/20/20 molar ratio) was dissolved in mesitylene to prepare 15 wt. % solution. To a portion of this solution was added B1000 (20 pphr), T67 (15 pphr), TAIC (10 pphr) DCP (0.75 pphr), Irganox-1076 (1.75 pphr) and Irgafos-168 (0.6 pphr).

### Example 5

### Preparation of Pre-Composition

The terpolymer of Example 2 (NB/HexNB/CyHexeneNB, 60/20/20 molar ratio) was dissolved in mesitylene to prepare 15 wt. % solution. To a portion of this solution was added B1000 (20 pphr), T67 (15 pphr), TAIC (10 pphr) DCP (0.5 pphr), Irganox-1076 (1.75 pphr) and Irgafos-168 (0.6 pphr). Additional amount of mesitylene (25 pphr) was also added to facilitate the dissolution of all of the components.

### Example 6

### Preparation of Pre-Composition

The terpolymer of Example 2 (NB/HexNB/CyHexeneNB, 60/20/20 molar ratio) was dissolved in decalin to prepare 15 wt. % solution. To a portion of this solution was added B1000 (20 pphr), T67 (15 pphr), TAIC (10 pphr) DCP (2 pphr), Irganox-1076 (1.75 pphr) and Irgafos-168 (0.6 pphr). Additional amount of decalin (50 pphr) was also added to facilitate the solubility of all of the components.

### Example 7

### Preparation of Pre-Composition

The terpolymer of Example 3 (NB/HexNB/CyHexeneNB, 60/20/20 molar ratio) was dissolved in decalin to make 15 wt. % solution. To this solution was added B1000 (20 pphr), T67 (15 pphr), TAIC (10 pphr) DCP (2 pphr), Irganox-1076 (1.75 pphr) and Irgafos-168 (0.6 pphr). Additional amount of decalin (50 pphr) was also added to facilitate the solubility of all of the components.

### Examples 8A-8B

### Fire Retardant Compositions

The pre-composition of Example 5 was mixed separately with DiDOPO (181 pphr) (Example 8A) and with PCO-900 (181 pphr) (Example 8B) to form two compositions of this invention, respectively Example 8A and Example 8B. Both compositions were rolled overnight to disperse well the organophosphorus compound. Glass cloth composites of these two compositions were prepared as follows. Glass cloth (NE glass cloth, Style #1280, 50 μm thick) composites were prepared by wetting about seven layers of rectangular glass cloth with the compositions of Examples 8A and 8B and heated on a hot plate at 120° C. for 1 hour to remove the solvent. This B-staged glass cloth composite stack was cured in an oven under nitrogen atmosphere at 190° C. for 1 hour to generate a composite of about 700-800 μm thick. The flammability of a rectangular sample (about 13 mm wide and 125 mm long) was tested following a procedure similar to ASTM D3801 (UL-94 flammability test) using a Propane Bunsen burner having a blue flame of about 2 cm long with a pad of cotton placed underneath the flame in an Aluminum pan. Aluminum pan was used to catch any drippings from the burning sample. The sample was kept vertically, and one end of the sample was kept in contact with the flame using a metal clamp for 10 seconds. Sample was removed from the flame and the after-flame time (the time took to self-extinguish the burning sample) was noted. This sample was contacted again with the flame (the same end as the first contact) for 10 seconds and the second after-flame time was noted. After the sample self-extinguished any sign of after-glow was also examined as UL-94 flammability test required, but such after-glow were not observed for the compositions tested. The occurrence of any drippings that made the cotton pad catch fire as well and any furious burning of the sample that cause the flame to spread up to the metal clamp was also noted. The results of this flame test are summarized in Table 1. The incorporation of either DiDOPO or PCO-900 to the pre-composition allowed the cured sample to achieve UL-94 V-0 rating under the condition at which the flame test was conducted. However, PCO-900 did not show good reliability properties as summarized in Table 1. The reliability of PCO-900 containing films were poor at 125° C. or 85° C./85% relative humidity storage as shown in Examples 12 and 14.

TABLE 1

| | After- | After- | | | |
|---|---|---|---|---|---|
| | flame | flame | Flamming | UL-94 | |
| Example No. | (t₁) | (t₂) | Drips | Rating | Reliability |
| Example 8A | 4 seconds | 1 seconds | No | V-0 | Good |
| Example 8B | 1 seconds | 3 seconds | No | V-0 | Bad |

### Examples 9A-9C

Portions of pre-composition of Example 4 were mixed with hexagonal boron nitride (h-BN, 0.7 μm average particle size from Showa Denko) and DiDOPO and rolled overnight to disperse thoroughly the insoluble particles. The sample preparation and flame test described in Example 8 were substantially repeated to prepare cured glass cloth composite stack. The results are summarized in Table 2. It is evident from the data presented in Table 2, incorporation of DiDOPO at 85 pphr results in cured sample achieving UL-94 V-0 rating under the condition at which the flame test was conducted while h-BN provides synergistic effect.

TABLE 2

| | | | | | After- | | After- | | UL-94 |
|---|---|---|---|---|---|---|---|---|---|
| Example No. | h-BN | | DiDOPO | | flame t₁ | | flame t₂ | | Rating |
| Example 9A | 85 | pphr | 85 | pphr | <2 | sec | <1 | sec | V-0 |
| Example 9B | 15 | pphr | 85 | pphr | 7 | sec | 3 | sec | V-0 |

| | | | | | | | | |
|---|---|---|---|---|---|---|---|---|
| Example 9C | 100 | pphr | 50 | pphr | >40 | sec | — | NR (fully |
| | | | | | | | | burnt) |

### Examples 10A-10B

Portions of pre-composition from Example 6 were mixed with DiDOPO (80 pphr for Example 10A and 100 pphr for Example 10B) and h-BN (35 pphr having 30 μm average particle size, from St. Gobain) and the compositions were further mixed using a Thinky mixer to disperse well all of the components in the composition. Glass cloth (NE glass cloth, Style #1280, 50 μm thick) composites were prepared by wetting about seven layers each of rectangular glass cloth with the compositions and heating in an oven at 130° C. for 1 hour under nitrogen atmosphere to remove the solvent. These B-staged glass cloth composite stacks were cured in an oven under vacuum at 190° C. for 1.5 hours to generate composites of about 700-800 μm thick. The flammability of rectangular samples (about 13 mm wide and 125 mm long) were tested using the procedure described in Example 8. The results of these flame tests are summarized in Table 3. The incorporation of DiDOPO and h-BN to the composition caused the cured samples to achieve UL-94 V-0 rating under the condition at which the flame tests were conducted. In Comparative Examples 1A and 1B where DiDOPO was replaced with a common flame retardant melamine, the glass cloth composites did not achieve UL-94 V-0 rating.

TABLE 3

| | | After- | | After- | UL-94 |
|---|---|---|---|---|---|
| Example No. | Flame Retardant | flame t₁ | | flame t₂ | Rating |
| Example 10A | DiDOPO, 80 pphr | 7 | sec | 0 sec | V-0 |
| Example 10B | DiDOPO, 100 pphr | 7 | sec | 0 sec | V-0 |
| Comp. Ex. 1A | Melamine, 80 pphr | 25 | sec | — | NR (fully |
| | | | | | burnt) |
| Comp. Ex. 1B | Melamine, 100 pphr | 25 | sec | — | NR (fully |
| | | | | | burnt) |

### Examples 11A-11D

Portions of the pre-composition from Example 6 were mixed with various amounts of h-BN (0.7 μm average particle size from Showa Denko) and various amounts of DiDOPO and rolled overnight to disperse the insoluble particles. Samples of these compositions were doctor-bladed on glass substrates and heated to 90° C. for 1 hour on a hot plate to remove the solvent. Pieces of these B-staged films were cut into about 2 cm×10 cm rectangles. These film pieces were sandwiched alternatively with seven layers of glass cloth (NE glass cloth, Style #1280, 50 μm thick), pressed together at about 4-6 MPa and heated to 200° C. for 1 hour. The cured composite stacks were vacuum dried at 190° C. for 1.5 hours. The flammability of rectangular samples (about 13 mm wide and 125 mm long) were tested using the procedure described in Example 8. The results of these flame tests are summarized in Table 4A. The incorporation of DiDOPO and h-BN to the composition caused the cured samples to achieve UL-94 V-0 rating under the condition at which the flame tests were conducted. It is important to note that incorporation of h-BN alone as in Example 11D results in a cured sample which burns completely as summarized in Table 4A. Similarly, the B-staged films (without glass cloth) were heated to 190° C. for 1.5 hours in an oven under vacuum to cross link the compositions to generate thermosets. The Dk and Df of these resin films at 10 GHz and their coefficient of thermal expansion (CTE) and glass transition temperatures (T_{g}) were measured and the results are summarized in Table 4B.

TABLE 4A

| | | | | | After- | After- | UL-94 |
|---|---|---|---|---|---|---|---|
| Example No. | h-BN | | DiDOPO | | flame t₁ | flame t₂ | Rating |
| Example 11A | 0 | pphr | 95 | pphr | 6 sec | 2 sec | V-0 |
| Example 11B | 12 | pphr | 106 | pphr | 13 sec | 5 sec | V-0 |
| Example 11C | 73 | pphr | 106 | pphr | 8 sec | 6 sec | V-0 |
| Example 11D | 95 | pphr | 0 | pphr | Fully | — | NR |
| | | | | | burnt | | |

TABLE 4B

| | Dk at | Df at | CTE | T_{g} |
|---|---|---|---|---|
| Example No. | 10 GHz | 10 GHz | (ppm/K) | (° C.) |
| Example 11A | 2.45 | 0.0009 | 134 | 254 |
| Example 11B | 2.44 | 0.0008 | 124 | 255 |
| Example 11C | 2.64 | 0.0008 | 111 | 264 |
| Example 11D | 2.76 | 0.0009 | 107 | 266 |

### Examples 12A-12B

### Reliability Studies of Films after Storage at 125° C.

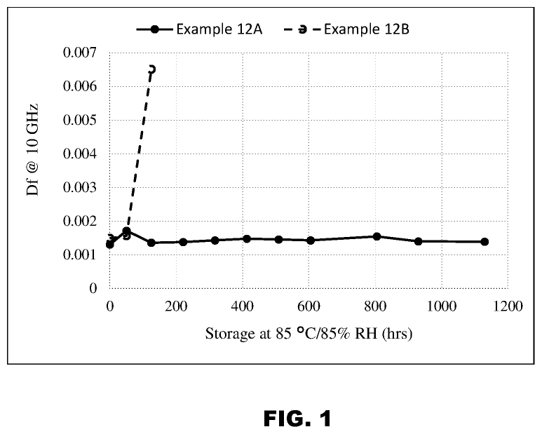

The pre-composition from Example 7 was mixed with h-BN (0.7 μm average particle size from Showa Denko, 25 pphr) and DiDOPO (25 pphr) for Example 12A and PCO-900 (25 pphr) for Example 12B. Both compositions were then rolled overnight to disperse the insoluble particles. These compositions were then spread separately on glass plates and rectangular glass cloth (NE glass cloth, Style #1280, 50 μm thick) samples were wetted. The solvent removed by heating to 130° C. for 1 hour in an oven with nitrogen inlet and an outlet. These B-staged samples were cured at 190° C. for 1.5 hours under vacuum in an oven. Dielectric Constant (Dk) and Dielectric Dissipation factor (Df) of the glass cloth composites were measured at 10 GHz. These samples were kept in an oven at 85° C. and at 85% relative humidity (RH) and their Dk and Df were measured periodically at 10 GHz to determine the reliability of these low loss compositions containing DiDOPO or PCO-900 flame retardant under humid and high temperature storage. FIG. 1 shows that the Df of the composite from Example 12A remained constant demonstrating a good reliability, the Df of Example 12B (demonstrated to be capable of attaining UL-94 V-0 rating as reported for Example 8B), increased rapidly due to its poor reliability under the storage conditions. Furthermore, the Dk of Example 12A at 10 GHz changed from 2.7 (initial) to 2.68 (1130 hours) and that is less than 1% drop. The Dk of Example 12B at 10 GHz changed from 2.77 (initial) to 3.2 (125 hours) and that is about 16% increase. The comparison of the reliability of the glass cloth composites of Example 12A and Example 12B suggests that although both DiDOPO and PCO-900 are capable of imparting flame retardancy to the low loss films while retaining low Dk (<3 at 10 GHz) and Df (<0.0015 at 10 GHz), the reliability of DiDOPO containing composition is superior under the storage conditions used. FIG. 1 shows graphical illustration of the excellent reliability of dielectric dissipation factor (Df) of the composition of Example 12A over the period of over 1130 hours. Thus, the composition of this invention can be used in a variety of applications as described herein, such as for example, mm-Wave Radar Antenna layers that require the operation under harsh conditions.

### Examples 13A-13D

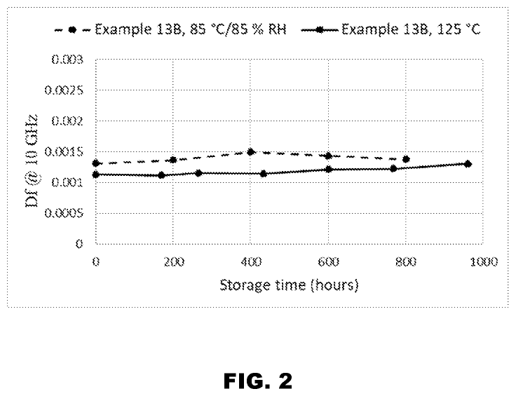

Portions of the pre-composition from Example 6 were mixed with DiDOPO (85 pphr) and h-BN (35 pphr having 30 μm average particle size, from St. Gobain or having less than 200 nm particle size from SS-nano) and mixed using a Thinky mixer to disperse DiDOPO and h-BN to form a homogeneous composition. Glass cloth (NE glass cloth, Style #1280, 50 μm thick) composites were prepared by wetting a rectangular glass cloth with the compositions and heating in an oven at 130° C. for 1 hour under nitrogen atmosphere to remove the solvent. These B-staged glass cloth composites were cured in an oven under vacuum at 190° C. for 1.5 hours to generate composites of about 100-200 μm thick. Dk and Df of these glass cloth composites were measured at 10 GHz. The results are summarized in Table 5A. Low Dk and Df values were retained or even slightly decreased for the composites containing DiDOPO. Samples from Example 13B were kept in ovens at 85° C. and 85% relative humidity (RH) in air and at 125° C. in air for extended periods of times and the Dk and Df were measured at regular time intervals at 10 GHz. The results are shown in FIG. 2. Good reliability at high temperature storage for about 900 hours are obtained. Similarly, the B-staged films (without glass cloth) of Example 13B and 13D were heated to 190° C. for 1.5 hours in an oven under vacuum to cross link the compositions to generate thermosets. The coefficient of thermal expansion (CTE) and glass transition temperatures (Tg) were measured and the results are summarized in Table 5B.

TABLE 5A

| | | | | Dk at | Df at |
|---|---|---|---|---|---|
| Example No. | h-BN | | DiDOPO | 10 GHz | 10 GHz |
| Example 13A | 30 | μm | No | 2.61 | 0.0011 |
| Example 13B | 30 | μm | Yes | 2.59 | 0.0009 |
| Example 13C | <200 | nm | No | 2.66 | 0.0012 |
| Example 13D | <200 | nm | Yes | 2.69 | 0.0011 |

TABLE 5B

| | | | | CTE | T_{g} |
|---|---|---|---|---|---|
| Example No. | h-BN | | DiDOPO | (ppm/K) | (° C.) |
| Example 13B | 30 | μm | Yes | 102 | 253 |
| Example 13D | <200 | nm | Yes | 105 | 249 |

### Example 14

The copolymer, NB/HexNB (80/20, molar ratio; M_{w}=197,000, PDI=1.8), (100.3 g) was dissolved in mesitylene (400 g) to produce a 20 wt. % solution. To several portions of this solution (13 g each) taken in a vial was added various flame retardant materials (DiDOPO (3 μm), DiDOPO (30 μm), Red P, PCO-900, FCP-796 and SPB-100 at two different concentrations (25 pphr and 100 pphr) as summarized in Table 6. Samples were rolled to mix the components.

The solutions were coated onto glass substrates, dried at room temperature overnight, heated on a hotplate at 90° C. for 2 hours, then further dried in a vacuum oven at 100° C. overnight. The film thickness in each of these samples was about 100 m. The films were then lifted with a razor or with a drop of water, then cut into the appropriate sample size: one 3×5 cm for Dk/Df measurement, and three 2×4 cm films for ion chromatography (IC) measurement. For time 0, a Dk/Df measurement was taken and one set of 2×4 cm samples were submitted to ion chromatography.

TABLE 6

| Example No. | Flame Retardant | Amount (pphr) |
|---|---|---|
| Example 14A | Control (polymer only) | — |
| Example 14B | DiDOPO (3 μm) | 25 |
| Example 14C | DiDOPO (30 μm) | 25 |
| Example 14D | Red P | 25 |
| Example 14E | PCO-900 | 25 |
| Example 14F | FCP-796 | 25 |
| Example 14G | SPB-100 | 25 |
| Example 14H | DiDOPO (3 μm) | 100 |
| Example 14I | DiDOPO (30 μm) | 100 |
| Example 14J | Red P | 100 |
| Example 14K | PCO-900 | 100 |
| Example 14L | FCP-796 | 100 |
| Example 14M | SPB-100 | 100 |

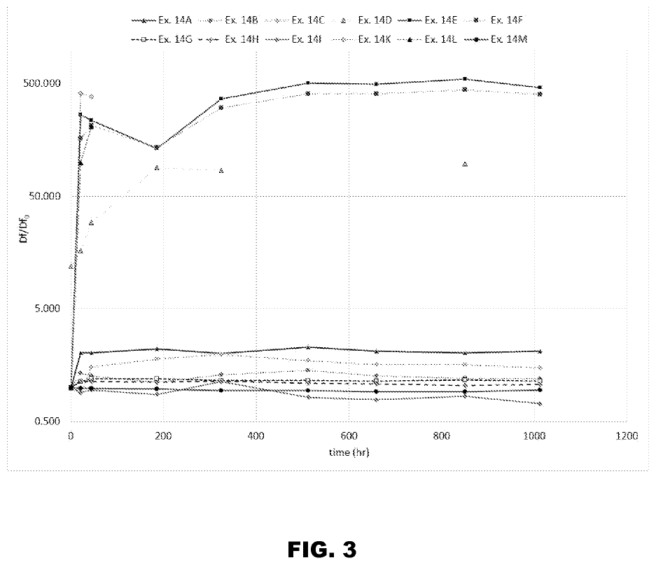

The Dk/Df films and the remaining IC samples were placed in a heat/humidity chamber at 85° C. and 85 percent relative humidity (RH) for a span of 1000 hrs. Dk/Df was measured at various times. One set of 2×4 cm samples were removed at 500 hrs for IC measurement. The remaining 2×4 cm samples were removed at the end of the study, 1000 hrs, for IC measurement. The ratio of Df value to initial value is graphically shown in FIG. 3. It is quite evident from the data presented in FIG. 3, the film samples from Examples 14A (control), 14B (DiDOPO, 3 μm, pphr) 14C (DiDOPO, 30 μm, 25 pphr), 14G (SPB-100, 25 pphr), 14H (DiDOPO, 3 μm, 100 pphr), 14M (SPB-100, 100 pphr), and 141 (DiDOPO, 30 μm, 100 pphr) exhibited very stable Df values, with less than 150% increase in value over time. More specifically, films of Examples 14A and 14C had an initial increase in the first 48 hours, while Examples 14B, 14G, 14H, 14M, and 14I were essentially remained same as their initial t=0 values. Examples 14K (PCO-900, 100 pphr), 14E (PCO-900, 25 pphr), 14F (FCP-796, 25 pphr), 14L (FCP-796, 100 pphr), and 14D (Red P, 25 pphr) all increased Df significantly by greater than 1000%. In the case of Red P, 25 pphr, Example 14D, it is known that the decomposition of red phosphorous in the presence of air and moisture yields phosphate ions, which should also increase the Df value. The phosphate (PO₄⁻³) concentrations (in ppb) measured from IC measurements further supports this, which was >700 ppm. In the case of FCP-796 and PCO-900 samples, the Df increased significantly as shown in FIG. 3, but there was not an appreciable phosphate concentration detected. This increase can be attributed to two different explanations. The first is that these flame retardants are soluble in water. The increase of Df could be due to a drastic increase in water absorption. The other explanation is that a large concentration of nitrite ions >1000 ppm were detected by IC. This ion formation would also increase the Df. In the case of Red P, 100 pphr, Example 14J, the film was curled and Dk/Df measurements could not be done. DiDOPO samples did not increase in phosphate concentration or nitrite, further indicating that it is stable under these conditions. The Dk values ranged from 2.2 to 2.5 for the samples which were stable. The samples which failed the reliability study (i.e., where Df increase of >150%) and a drastic increase of Df, such as PCO-900 and Red P, the Dk values increased to 3 or 4.

### Example 15

The compositions from Examples 14A (control), 14H (DiDOPO, 3 μm, 100 pphr) and 14J (Red P, 100 pphr), respectively, were coated onto copper foil textured side up, dried at room temperature overnight, heated on a hotplate at 90° C. for 2 hours, then further dried in a vacuum oven at 100° C. overnight. Samples were cut into 3 pieces. One sample was reserved for time 0 observations (t=0). The other two samples were placed into an 85° C./85 percent relative humidity (RH) chamber. Samples were removed at 500 hrs (t=500) and 1000 hrs (t=1000). Visual observations were recorded as summarized in Table 7. DiDOPO and the control films had no visual factors to indicate aging or corrosion. Meanwhile the Red P sample showed catastrophic failure. On the bottom of the film the corrosion is seen only on the copper where the film is located on the other side.

TABLE 7

| Example No. | t = 0 | t = 500 | t = 1000 |
|---|---|---|---|
| Example 14A | Film: clear and | Film: clear and | Film: clear and |
| | colorless | colorless | colorless |
| | Copper: shiny, | Copper: shiny, some | Copper: shiny, some |
| | brown-red color | areas of dulling, | areas of dulling, |
| | | brown-red color | brown-red color |
| Example 14H | Film: white film | Film: white film | Film: white film |
| | Copper: shiny, | Copper: shiny, some | Copper: shiny, some |
| | brown-red color | areas of dulling, | areas of dulling, |
| | | brown-red color | brown-red color |
| Example 14J | Film: red film | Film: dark film with | Film was removed as |
| | Copper: shiny, | spots of green | it was determined it |
| | brown-red color | Copper: dull, green, | could not withstand |
| | | bubbling surface, | another 500 hrs |
| | | areas with holes | |

### Comparative Examples 1A-1B

Portions of the pre-composition from Example 6 were mixed with melamine (80 pphr for Comparative Example 1A and 100 pphr for Comparative Example 1B) and h-BN (35 pphr having 30 μm average particle size purchased from St. Gobain) and mixed using a Thinky mixer to disperse melamine and h-BN. Glass cloth (NE glass cloth, Style #1280, 50 μm) composites were prepared by wetting about seven layers of rectangular glass cloth with the melamine and h-BN dispersed formulations and heated in an oven at 130° C. for 1 hour under nitrogen atmosphere to remove the solvent. This B-staged glass cloth composite stacks were cured in an oven under vacuum at 190° C. for 1.5 hours to generate composites of about 700-800 μm thick. The flammability of rectangular samples (about 13 mm wide and 125 mm long) were tested using the procedure described in Example 8. The results of this flame test is reported in Table 3. The incorporation of melamine and h-BN to the formulation did not cause the cured samples to achieve UL-94 V-0 rating under the condition at which the flame tests were conducted.

Although the invention has been illustrated by certain of the preceding examples, it is not to be construed as being limited thereby; but rather, the invention encompasses the generic area as hereinbefore disclosed. Various modifications and embodiments can be made without departing from the spirit and scope thereof.

What is claimed is:

1. A composition comprising:
a) a polymer comprising:
i) at least one first repeating unit represented by formula (IA), said first repeating unit is derived from a monomer of formula (I): 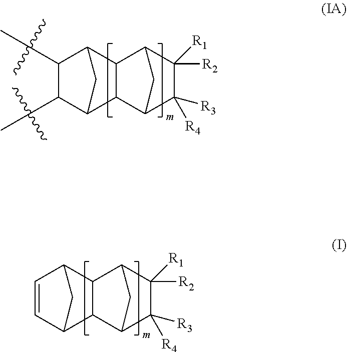
wherein: [symbol]
denotes a place of bonding with another repeat unit;
m is an integer 0, 1 or 2;
R₁, R₂, R₃ and R₄ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₁ and R₂ taken together with one of R₃ and R₄ and the carbon atoms to which they are attached to form a substituted or unsubstituted (C₅-C₁₄)cyclic, (C₅-C₁₄)bicyclic or (C₅-C₁₄)tricyclic ring; and
ii) at least one second repeating unit represented by formula (IIA), said second repeating unit is derived from a monomer of formula (II): 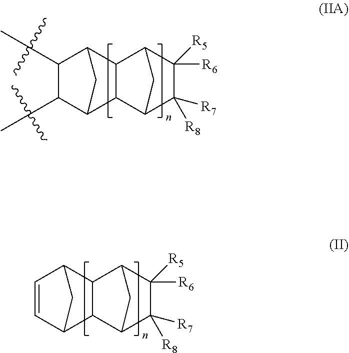
wherein: [symbol]
denotes a place of bonding with another repeat unit;
n is an integer 0, 1 or 2;
at least one of R₅, R₆, R₇ and R₈ is selected from the group consisting of methylidene, ethylidene, vinyl, linear or branched (C₃-C₁₆)alkenyl, (C₃-C₁₀)cycloalkenyl, (C₆-C₁₂)bicycloalkenyl and (C₆-C₁₂)aryl(C₂-C₁₆)alkenyl and the remaining R₅, R₆, R₇ and R₈ are the same or different and each independently selected from the group consisting of hydrogen, methyl, ethyl, linear or branched (C₃-C₁₆)alkyl, (C₃-C₁₀)cycloalkyl, (C₆-C₁₂)bicycloalkyl, (C₆-C₁₂)aryl and (C₆-C₁₂)aryl(C₁-C₆)alkyl; or
one of R₅ and R₆ taken together with one of R₇ and R₈ and the carbon atoms to which they are attached to form a substituted or unsubstituted (C₅-C₁₄)cyclic, (C₅-C₁₄)bicyclic or (C₅-C₁₄)tricyclic ring containing at least one double bond;
and
wherein the second repeat unit is present at an amount in the range of from about zero mole percent to about forty mole percent based on total moles of first and second repeat units;
b) a crosslinking agent selected from the group consisting of: 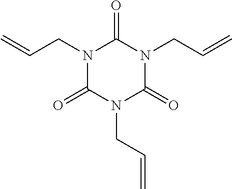 [SMILES: C=CCn1c(=O)n(CC=C)c(=O)n(CC=C)c1=O]
1,3,5-triallyl-1,3,5-triazinane-2,4,6-trione (TAIC); and 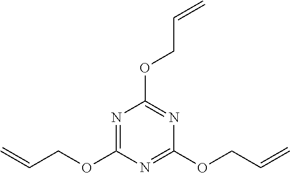 [SMILES: C=CCOc1nc(OCC=C)nc(OCC=C)n1]
2,4,6-tris(allyloxy)-1,3,5-triazine (TAC);
b) an organophosphorus compound selected from the group consisting of:
a compound of formula (III): 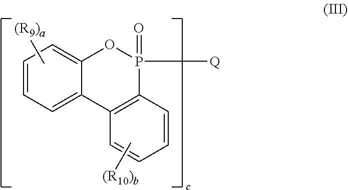
wherein:
each a and b is independently an integer from 0 to 5;
c is an integer from 2 to 4;
Q is selected from the group consisting of a divalent or trivalent (C₂-C₂₄)alkyl, divalent NH(C₂-C₆)alkylNH and divalent O(C₂-C₆)alkylNH, wherein said alkyl is optionally substituted with one or more groups selected from the group consisting of methyl, ethyl, linear or branched (C₃-C₆)alkyl, (C₆-C₁₂)aryl and (C₅-C₁₂)heteroaryl;
each R₉ and R₁₀ is independently selected from the group consisting of hydrogen, methyl, ethyl, and linear or branched (C₃-C₆)alkyl;
a compound of formula (IV): 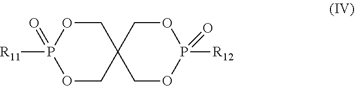
wherein:
each R₁₁ and R₁₂ is independently selected from the group consisting of methyl, ethyl, linear or branched (C₃-C₆)alkyl, phenyl, methoxy, ethoxy, linear or branched (C₃-C₆)alkoxy, phenoxy and 6H-phosphanthridine 5-oxide-(C₁-C₃)alkyl;
d) a tackifier; and
e) one or more additives selected from the group consisting of a free radical initiator, an antioxidant, an amino compound, a synergist and a mixture in any combination thereof; and
wherein said organophosphorus compound is present at an amount greater than 70 weight percent based on the amount of polymer and said composition when formed into film has a UL-94 rating of at least V-1, a dissipation factor (Df) of less than 0.001 at 10 GHz and a dielectric constant (Dk) of less than 2.5 at 10 GHz.

2. The composition according to claim 1, wherein the first repeat unit of the polymer is derived from the monomer of formula (I) selected from the group consisting of: 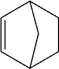
bicyclo[2.2.1]hept-2-ene (norbornene or NB); 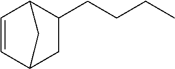
5-butylbicyclo[2.2.1]hept-2-ene (BuNB 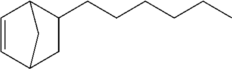
5-hexylbicyclo[2.2.1]hept-2-ene (HexNB); 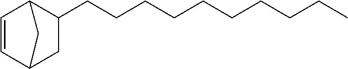 [SMILES: CCCCCCCCCCC1CC2C=CC1C2]
5-decylbicyclo[2.2.1]hept-2-ene (DecNB); 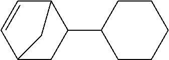 [SMILES: C1=CC2CC1CC2C1CCCCC1]
5-cyclohexylbicyclo[2.2.1]hept-2-ene (CyHexNB); 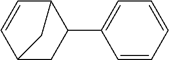 [SMILES: C1=CC2CC1CC2c1ccccc1]
5-phenylbicyclo[2.2.1]hept-2-ene (PhNB); 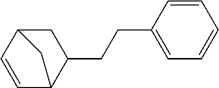 [SMILES: C1=CC2CC1CC2CCc1ccccc1]
5-phenethylbicyclo[2.2.1]hept-2-ene (PENB); 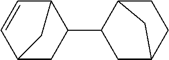 [SMILES: C1=CC2CC1CC2C1CC2CCC1C2]
2,2′-bi bicyclo[2.2.1]heptan-5-ene) (NBANB); 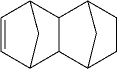 [SMILES: C1=CC2CC1C1C3CCC(C3)C21]
1,2,3,4,4a,5,8,8a-octahydro-1,4:5,8-dimethanonaphthalene (TD); and 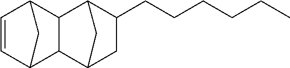 [SMILES: CCCCCCC1CC2CC1C1C3C=CC(C3)C21]
2-hexyl-1,2,3,4,4a,5,8,8a-octahydro-1,4:5,8-dimethanonaphthalene (HexTD).

3. The composition according to claim 1, wherein the second repeat unit of the polymer is derived from the monomer of formula (II) selected from the group consisting of: 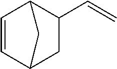
5-vinylbicyclo[2.2.1]hept-2-ene (VNB); 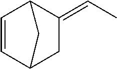
5-ethylidenebicyclo[2.2.1]hept-2-ene ENB); 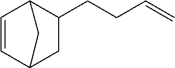
5-(but-3-en-1-yl)bicyclo[2.2.1]hept-2-ene (ButenylNB); 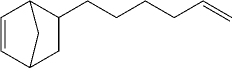
5-(hex-5-en-1-yl)bicyclo[2.2.1]hept-2-ene (HexenylNB); 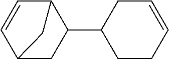 [SMILES: C1=CCC(C2CC3C=CC2C3)CC1]
5-(cyclohex-3-en-1-yl)bicyclo[2.2.1]hept-2-ene (CyHexeneNB); 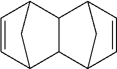 [SMILES: C1=CC2CC1C1C3C=CC(C3)C21]
1,4,4a,5,8,8a-hexahydro-1,4:5,8-dimethanonaphthalene (TDD); 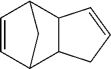
3a,4,7,7a-tetrahydro-1H-4,7-methanoindene (DCPD); and 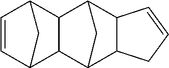 [SMILES: C1=CC2C(C1)C1CC2C2C3C=CC(C3)C12]
3a,4,4a,5,8,8a,9,9a-octahydro-1H-4,9:5,8-dimethanocyclopenta[b]naphthalene (CPD3).

4. The composition according to claim 1, wherein the compound of formula (III) is selected from the group consisting of: 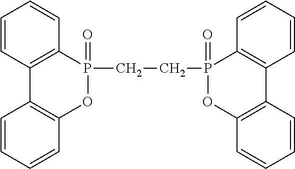 [SMILES: O=P1(CCP2(=O)Oc3ccccc3-c3ccccc32)Oc2ccccc2-c2ccccc21]
6,6′-(ethane-1,2-diyl)bis(dibenzo[c,e][1,2]oxaphosphinine 6-oxide), also known as DiDOPO; 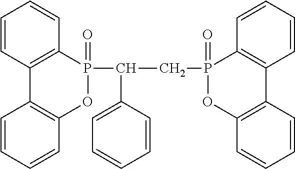 [SMILES: O=P1(CC(c2ccccc2)P2(=O)Oc3ccccc3-c3ccccc32)Oc2ccccc2-c2ccccc21]
6,6′-(1-phenylethane-1,2-diyl)bis(dibenzo[c,e][1,2]oxaphosphinine 6-oxide), also known as DiDOPO2; 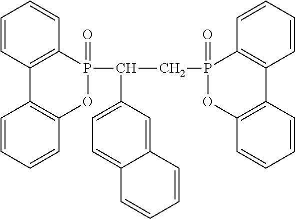 [SMILES: O=P1(CC(c2ccc3ccccc3c2)P2(=O)Oc3ccccc3-c3ccccc32)Oc2ccccc2-c2ccccc21]
6,6′-(1-(naphthalen-2-yl)ethane-1,2-diyl)bis(dibenzo[c,e][1,2]oxaphosphinine 6-oxide), also known as DiDOPO3; 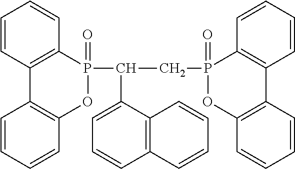 [SMILES: O=P1(CC(c2cccc3ccccc23)P2(=O)Oc3ccccc3-c3ccccc32)Oc2ccccc2-c2ccccc21]
6,6′-(1-(naphthalen-1-yl)ethane-1,2-diyl)bis(dibenzo[c,e][1,2]oxaphosphinine 6-oxide); 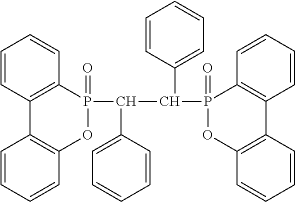 [SMILES: O=P1(C(c2ccccc2)C(c2ccccc2)P2(=O)Oc3ccccc3-c3ccccc32)Oc2ccccc2-c2ccccc21]
6,6′-(1,2-diphenylethane-1,2-diyl)bis(dibenzo[c,e][1,2]oxaphosphinine 6-oxide); 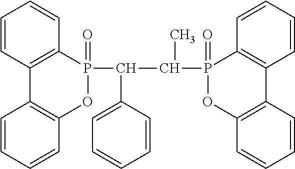 [SMILES: CC(C(c1ccccc1)P1(=O)Oc2ccccc2-c2ccccc21)P1(=O)Oc2ccccc2-c2ccccc21]
6,6′-(1-phenylpropane-1,2-diyl)bis(dibenzo[c,e][1,2]oxaphosphinine 6-oxide); 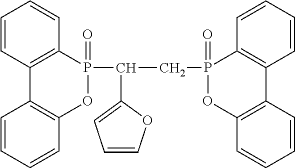 [SMILES: O=P1(CC(c2ccco2)P2(=O)Oc3ccccc3-c3ccccc32)Oc2ccccc2-c2ccccc21]
6,6′-(1-(furan-2-yl)ethane-1,2-diyl)bis(dibenzo[c,e][1,2]oxaphosphinine 6-oxide); 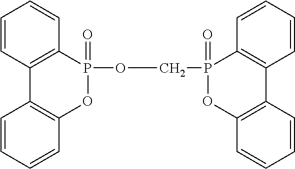 [SMILES: O=P1(COP2(=O)Oc3ccccc3-c3ccccc32)Oc2ccccc2-c2ccccc21]
6-((6-oxidodibenzo[c,e][1,2]oxaphosphinin-6-yl)methoxy)dibenzo[c,e][1,2]oxa-phosphinine 6-oxide, also known as DiDOPOMeO; 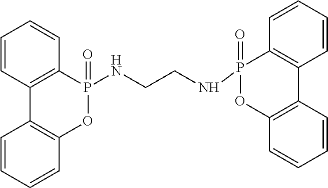 [SMILES: O=P1(NCCNP2(=O)Oc3ccccc3-c3ccccc32)Oc2ccccc2-c2ccccc21]
6,6′-(ethane-1,2-diylbis(azanediyl))bis(dibenzo[c,e][1,2]oxaphosphinine 6-oxide), also known as EDAB-DOPO; 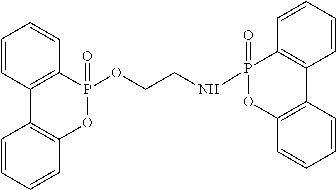 [SMILES: O=P1(NCCOP2(=O)Oc3ccccc3-c3ccccc32)Oc2ccccc2-c2ccccc21]
6-(2-((6-oxidodibenzo[c,e][1,2]oxaphosphinin-6-yl)amino)ethoxy)dibenzo[c,e][1,2]oxaphosphinine 6-oxide, also known as EAB-DOPO.

5. The composition according to claim 1, wherein the compound of formula (IV) is selected from the group consisting of: 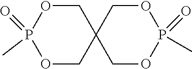
3,9-dimethyl-2,4,8,10-tetraoxa-3,9-diphosphaspiro[5.5]undecane 3,9-dioxide (available commercially as AFLAMMIT® PCO-900 from Thor Flame Retardants); 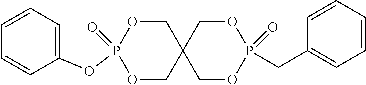 [SMILES: O=P1(Cc2ccccc2)OCC2(CO1)COP(=O)(Oc1ccccc1)OC2]
3,9-diphenoxy-2,4,8,10-tetraoxa-3,9-diphosphaspiro[5.5]undecane 3,9-dioxide (available commercially as AFLAMMIT® PCO-910 from Thor Flame Retardants); and 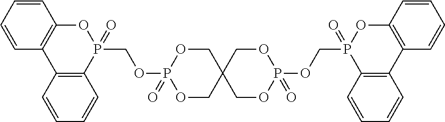 [SMILES: O=P1(OCP2(=O)Oc3ccccc3-c3ccccc32)OCC2(CO1)COP(=O)(OCP1(=O)Oc3ccccc3-c3ccccc31)OC2]
3,9-bis((6-oxidodibenzo[c,e][1,2]oxaphosphinin-6-yl)methoxy)-2,4,8,10-tetraoxa-3,9-diphosphaspiro[5.5]undecane 3,9-dioxide.

6. The composition according to claim 1, which further comprises hexagonal boron nitride having a particle size in the range of from about 0.05 micrometer to about 50 micrometer and wherein the hexagonal boron nitride is in the form of platelets.

7. The composition according to claim 1, wherein hexagonal boron nitride is present at an amount in the range of from about 10 weight percent to about 120 weight percent based on the amount of the polymer.

8. The composition according to claim 1, which further comprises a compound selected from the group consisting of an inorganic carbide, an inorganic oxide, an inorganic nitride, an inorganic sulfide, an inorganic hydroxide, inorganic borate, inorganic silicate, inorganic molybdate, inorganic stannate and an inorganic phosphide.

9. The composition according to claim 1, which further comprises a compound selected from the group consisting of silicon carbide, boron carbide, silicon dioxide, aluminum oxide, aluminum silicate (SiO₂/Al₂O₁₀), lithium aluminum silicate, zirconium dioxide, silicon nitride, aluminum nitride, aluminum hydroxide, titanium nitride, gallium nitride, boron nitride carbide, titanium boride, tungsten disulfide, zinc borate, zinc molybdate, zinc stannate, and mixtures in any combination thereof.

10. The composition according to claim 1, wherein the tackifier is selected from the group consisting of: 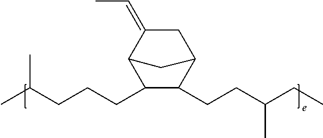
ethylene-propylene-ethylidenenorbornene terpolymer, where e is at least 100 (T67); 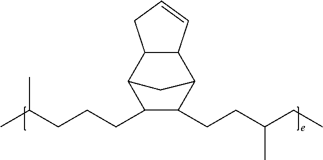
ethylene-propylene-dicyclopentadiene terpolymer, where e is at least 100 (T65); 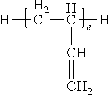
1,2-butadiene rubber, where e is at least 100 (B1000); 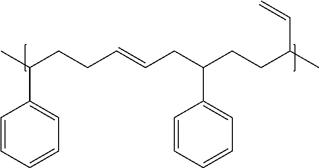
styrene/butadiene rubbers 1; 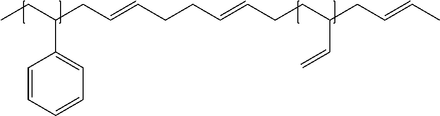
styrene/butadiene rubbers 2; 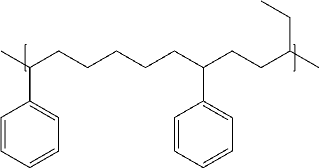
hydrogenated styrene/butadiene rubbers 1; and 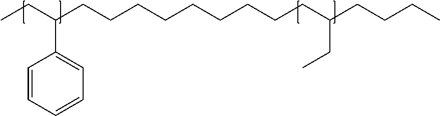
hydrogenated styrene/butadiene rubbers 2.

11. The composition according to claim 1, wherein the free radical generator is selected from the group consisting of: 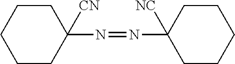 [SMILES: N#CC1(N=NC2(C#N)CCCCC2)CCCCC1]
1,1′-(diazene-1,2-diyl)bis(cyclohexane-1-carbonitrile) (V-40); 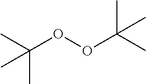
di-tert-butyl peroxide; 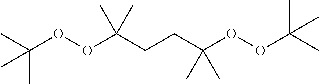 [SMILES: CC(C)(C)OOC(C)(C)CCC(C)(C)OOC(C)(C)C]
2,5-bis(tert-butylperoxy)-2,5-dimethylhexane (Luperox-101); 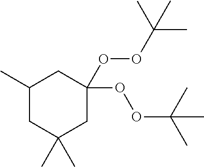 [SMILES: CC1CC(C)(C)CC(OOC(C)(C)C)(OOC(C)(C)C)C1]
1,1-bis(tert-butylperoxy)-3,3,5-trimethylcyclohexane (Luperox-231); 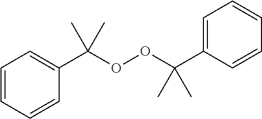 [SMILES: CC(C)(OOC(C)(C)c1ccccc1)c1ccccc1]
dicumyl peroxide (DCP); 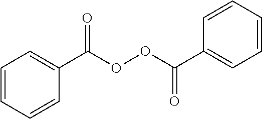 [SMILES: O=C(OOC(=O)c1ccccc1)c1ccccc1]
benzoyl peroxide; 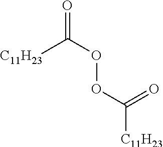
dodecanoic peroxyanhydride (Luperox-LP) 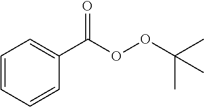
tert-butyl benzoperoxoate (Luperox-P); and 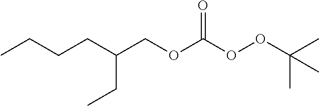 [SMILES: CCCCC(CC)COC(=O)OOC(C)(C)C]
tert-butyl (2-ethylhexyl) carbonoperoxoate (Luperox-TBEC).

12. The composition according to claim 1, which is selected from the group consisting of:
a dispersion containing a mixture of a terpolymer of norbornene (NB), 5-butylbicyclo[2.2.1]hept-2-ene (BuNB) and 5-(but-3-en-1-yl)bicyclo [2.2.1]hept-2-ene (ButenylNB); 1,3,5-triallyl-1,3,5-triazinane-2,4,6-trione (TAIC), 1,2-butadiene rubber (B1000), dicumyl peroxide (DCP) and 6,6′-(ethane-1,2-diyl)bis(dibenzo[c,e][1,2]oxaphosphinine 6-oxide) (DiDOPO);
a dispersion containing a mixture of a terpolymer of norbornene (NB), 5-butylbicyclo[2.2.1]hept-2-ene (BuNB) and 5-(but-3-en-1-yl)bicyclo [2.2.1]hept-2-ene (ButenylNB); 1,3,5-triallyl-1,3,5-triazinane-2,4,6-trione (TAIC), 1,2-butadiene rubber (B1000), poly-aryl ether cross linker end capped with methacrylate groups (SA9000), dicumyl peroxide (DCP) and 6,6′-(ethane-1,2-diyl)bis(dibenzo[c,e][1,2]oxaphosphinine 6-oxide) (DiDOPO);
a dispersion containing a mixture of a terpolymer of norbornene (NB), 5-butylbicyclo[2.2.1]hept-2-ene (BuNB) and 5-(hex-5-en-1-yl)bicyclo[2.2.1]hept-2-ene (HexenylNB); 1,3,5-triallyl-1,3,5-triazinane-2,4,6-trione (TAIC), 1,2-butadiene rubber (B1000), ethylene-propylene-ethylidenenorbornene terpolymer (T67), 3,5-bis(1,1-dimethylethyl)-4-hydroxy-octadecyl ester benzenepropanoic acid (Irganox 1076), tris(2,4-ditert-butylphenyl)phosphite (Irgafos 168), dicumyl peroxide (DCP) and 6,6′-(ethane-1,2-diyl)bis(dibenzo[c,e][1,2]oxaphosphinine 6-oxide) (DiDOPO); and
a dispersion containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber (B1000), ethylene-propylene-ethylidenenorbornene terpolymer (T67), 3,5-bis(1,1-dimethylethyl)-4-hydroxy-octadecyl ester benzenepropanoic acid (Irganox 1076), tris(2,4-ditert-butylphenyl)phosphite (Irgafos 168), dicumyl peroxide (DCP) and 6,6′-(ethane-1,2-diyl)bis(dibenzo[c,e][1,2]oxaphosphinine 6-oxide) (DiDOPO).

13. A film formed from the composition according to claim 1.

14. The film according to claim 13, which contains 6,6′-(ethane-1,2-diyl)bis(dibenzo[c,e][1,2]oxaphosphinine 6-oxide) (DiDOPO) in the amount higher than ninety weight percent based on the polymer and has a dielectric constant (Dk) of less than 2.5 at a frequency of 10 GHz, a dielectric dissipation factor (Df) of less than 0.001 and a UL-94 rating of at least V-0.

15. The composition according to claim 6, which is selected from the group consisting of:
a dispersion containing a mixture of a terpolymer of norbornene (NB), 5-butylbicyclo[2.2.1]hept-2-ene (BuNB) and 5-(but-3-en-1-yl)bicyclo [2.2.1]hept-2-ene (ButenylNB); 1,3,5-triallyl-1,3,5-triazinane-2,4,6-trione (TAIC), 1,2-butadiene rubber (B1000), dicumyl peroxide (DCP), 6,6′-(ethane-1,2-diyl)bis(dibenzo[c,e][1,2]oxaphosphinine 6-oxide) (DiDOPO) and hexagonal boron nitride (h-BN);
a dispersion containing a mixture of a terpolymer of norbornene (NB), 5-butylbicyclo[2.2.1]hept-2-ene (BuNB) and 5-(but-3-en-1-yl)bicyclo [2.2.1]hept-2-ene (ButenylNB); 1,3,5-triallyl-1,3,5-triazinane-2,4,6-trione (TAIC), 1,2-butadiene rubber (B1000), poly-aryl ether cross linker end capped with methacrylate groups (SA9000), dicumyl peroxide (DCP), 6,6′-(ethane-1,2-diyl)bis(dibenzo[c,e][1,2]oxaphosphinine 6-oxide) (DiDOPO) and hexagonal boron nitride (h-BN);
a dispersion containing a mixture of a terpolymer of norbornene (NB), 5-butylbicyclo[2.2.1]hept-2-ene (BuNB) and 5-(hex-5-en-1-yl)bicyclo[2.2.1]hept-2-ene (HexenylNB); 1,3,5-triallyl-1,3,5-triazinane-2,4,6-trione (TAIC), 1,2-butadiene rubber (B1000), ethylene-propylene-ethylidenenorbornene terpolymer (T67), 3,5-bis(1,1-dimethylethyl)-4-hydroxy-octadecyl ester benzenepropanoic acid (Irganox 1076), tris(2,4-ditert-butylphenyl)phosphite (Irgafos 168), dicumyl peroxide (DCP), 6,6′-(ethane-1,2-diyl)bis(dibenzo[c,e][1,2]oxaphosphinine 6-oxide) (DiDOPO) and hexagonal boron nitride (h-BN); and
a dispersion containing a mixture of a terpolymer of norbornene (NB), 5-hexylbicyclo[2.2.1]hept-2-ene (HexNB) and 5-(cyclohex-3-en-1-yl)bicyclo[2.2.1]hept-2-ene (CyclohexeneNB); 1,3,5-triallyl-1,3,5-triazinane-2,4,6-trione (TAIC), 1,2-butadiene rubber (B1000), ethylene-propylene-ethylidenenorbornene terpolymer (T67), 3,5-bis(1,1-dimethylethyl)-4-hydroxy-octadecyl ester benzenepropanoic acid (Irganox 1076), tris(2,4-ditert-butylphenyl)phosphite (Irgafos 168), dicumyl peroxide (DCP), 6,6′-(ethane-1,2-diyl)bis(dibenzo[c,e][1,2]oxaphosphinine 6-oxide) (DiDOPO) and hexagonal boron nitride (h-BN).

16. The film according to claim 15, which contains 6,6′-(ethane-1,2-diyl)bis(dibenzo[c,e][1,2]oxaphosphinine 6-oxide) (DiDOPO) in the amount higher than hundred weight percent based on the polymer, hexagonal boron nitride in the amount ranging from about 10 weight percent to about seventy five weight percent based on the polymer and has a dielectric constant (Dk) of less than 2.7 at a frequency of 10 GHz, a dielectric dissipation factor (Df) of less than 0.0009 and a UL-94 rating of at least V-0.

17. A glass fabric composite formed from the composition of claim 1.

18. A glass fabric composite formed from the composition of claim 6.

19. The glass fabric composite according to claim 17, which has a dielectric constant (Dk) in the range of from about 2.4 to about 2.5 and a dielectric dissipation factor (Df) from about 0.001 to 0.0009 at a frequency of 10 GHz and a UL-94 rating of at least V-0.

20. The glass fabric composite according to claim 18, which has a dielectric constant (Dk) in the range of from about 2.5 to about 2.7 and a dielectric dissipation factor (Df) from about 0.001 to 0.0008 at a frequency of 10 GHz and a UL-94 rating of at least V-0.
